(19) United States
(12) Patent Application Publication
(10) Pub. No.: US 2025/0118171 A1
(43) Pub. Date: Apr. 10, 2025

(54) CARD-BASED ELECTRONIC GAMING SYSTEM FOR PLAYING WHEEL GAMES

(71) Applicant: Generation Z, LLC, Columbus, MN (US)

(72) Inventors: Stephen Deckoff, Columbus, MN (US); Joshua Gago, Rice Lake, WI (US); Jason Nordby, North St. Paul, MN (US); Lynnette Blom, Brook Park, MN (US)

(21) Appl. No.: 18/905,837

(22) Filed: Oct. 3, 2024

Related U.S. Application Data
(60) Provisional application No. 63/588,138, filed on Oct. 5, 2023.

(51) Int. Cl. G07F 17/32

(52) U.S. Cl. CPC G07F 17/3293; G07F 17/3211

(57) ABSTRACT

Disclosed herein is an electronic gaming system using common playing cards including player computing devices that provide individualized gaming interfaces for players and a gaming computing device that can: based on sets of playing cards with one set being dealt successive to another set, continuously identify the sets, based on a request to play a game of roulette from at least one player computing device, identify a first set of playing cards, receive, from at least one player computing device, a bet on an outcome of the game of roulette, identify, among the first set of playing cards, a first card, determine a roulette value for the first card using mapping data, the mapping data indicating a mapping of card values to roulette values, transmit, to the at least one player computing device, data representative of the first card and the respective roulette value, and determine the game outcome.

### INCORPORATION BY REFERENCE

This application claims the priority benefit of U.S. Provisional Patent Application No. 63/588,138, filed Oct. 5, 2023, the entirety of which is incorporated by reference herein.

### TECHNICAL FIELD

This document generally describes devices, systems, and methods related to electronic gaming systems that provide electronic gaming, such as roulette gaming or other games using wheels, using playing cards, such as physical playing cards.

### BACKGROUND

Electronic gaming systems and devices have traditionally relied on random number generators to determine gaming outcomes that are displayed to players as part of the game. Additionally, electronic gaming systems receive player inputs based on the displayed gaming outcomes. For example, while a number of variations exist, electronic gaming devices typically deal a number of cards based on the type of game being played. An outcome of the game (e.g., whether the player won and the odds that apply to the win) may be determined based on a final resulting hand of the player. The player's cards can be determined by the electronic gaming devices using random number generators that are implemented by the electronic gaming devices. Players can play different games but can receive same sets of cards as other players who play different games. The players can also play at different paces relative to each other.

Moreover, roulette is a game of skill with a large number of variations, including variations in format of gameplay, player actions (e.g., betting), and determination of gaming outcomes. In general, in a traditional game of roulette, a dealer sets a ball in a spinning wheel as players place their bets on a roulette table. Eventually the ball drops into a pocket on the spinning wheel, or a roulette slot. Each pocket is marked with a number between 0 and 36. If the ball lands in the pocket of a number on which a player wagered on the roulette table, then the player wins. The player can place different types of bets, including inside bets and outside bets. Inside bets include bets or wagers that are made inside a box on the roulette table containing the numbers 0 through 36 while bets made outside the box on the roulette table are outside bets.

### SUMMARY

The document generally describes electronic gaming systems. More particularly, this document describes electronic gaming techniques for wheel games (e.g., roulette games) based on physical cards (e.g., playing cards) dealt at a physical gaming table. The electronic gaming techniques described herein can deal common cards for accommodating multiple players who play the games at different timings and/or paces. For example, sets of cards can be continuously dealt at a physical gaming table (for example by a dealer) at a relatively fast rate or a desired rate. While being continuously dealt, each set of cards can be used for cards being selected and presented to each of multiple players and used for a particular stage of the game being currently played by each of the players. For example, while cards are being continuously dealt at the table, each player can be presented with one, some, all of the cards that are dealt at a particular moment that the player requests to start a game of roulette or place a bet in a current game of roulette. As a result, each player can play one or more games at their preferred pace, without being affected by paces and play stages of the other players at the physical gaming table or other players that are remote from the physical gaming table.

In general, a game of roulette traditionally involves players placing bets on a roulette table while a ball is set in a spinning wheel having pockets that are assigned roulette numbers. The ball eventually drops into a pocket, and a dealer pays out bets that were placed for the roulette number assigned to that pocket. Card-based electronic gaming systems for roulette can be programmed to continuously deal common cards used by all players playing at the particular table, including players who are playing virtually or otherwise remote from the particular table, and convert card values to roulette numbers using mapping data. Instead of using a traditional roulette wheel, card-based electronic gaming systems can match card values to different number values (e.g., 36 values) on the wheel. For example, a set of cards that were dealt within a threshold amount of time after a game of roulette started can be identified. Using the mapping data, a card in the set of cards can be identified as being mapped to a roulette value. For example, a first card in a card sequence of the set of cards that is mapped to a roulette value can be identified. Sometimes, any cards in the set of cards that are not mapped to roulette values may be discarded from the set and from being dealt in subsequent sets. In some implementations, the discarded cards can be used in subsequent sets of cards. The identified card with its corresponding roulette value can then be presented at computing devices of players playing the game. Gaming outcomes and payout can also be automatically determined based on the roulette value, bets placed by the players, and roulette gaming rules.

Moreover, the continuously dealt common cards can be used not only for players playing roulette, but also for players playing a variety of other games, such as poker, baccarat, and craps. Card-based electronic gaming systems for roulette can also be programmed to allow the players at the table (and remote from the table) to play roulette and other games at their desired paces, without having to rely on timing of other players playing the game. For instance, in one example of a roulette game provided with common cards via a dealer-assist electronic gaming system, a dealer can physically deal five cards (e.g., scan five physical cards from a deck/shoe of cards). For players who start the game and place their bets at a same time, the system reads and identifies a card in that set that maps to a roulette number on a traditional roulette wheel. The card and the mapped roulette value can be transmitted to each computing device of those players and their respective gaming outcomes/payouts can be determined based on that mapped roulette value. For players who start the game at a second time, the system can identify a set of cards that are dealt at the second time and use that set of cards to identify a roulette number for those players.

In addition to a main game (e.g., roulette) being played, the sets of cards being continuously dealt and used for identifying roulette values can also be used for placing a variety of side bets. Side bets are bonus bets placed on a round of roulette that can be staked at the start of a round of roulette along with main bets/wagers, before cards are dealt and/or before a roulette value is identified. Various different side bets can be placed by the players, as described further below.

One or more embodiments described herein can include an electronic gaming system using common playing cards. The system includes a plurality of player computing devices that are configured to provide individualized gaming interfaces for a plurality of players; and a gaming computing device that is in communication with the plurality of player computing devices, the gaming computing device configured to: based on a plurality of sets of playing cards with one set of playing cards being dealt successive to another set of playing cards, continuously identify the plurality of sets of playing cards; based on a request to play a game of roulette from at least one of the plurality of player computing devices, identify a first set of playing cards among the plurality of sets of playing cards being continuously identified; receive, from at least one of the plurality of player computing devices, a bet on an outcome of the game of roulette; identify, among the first set of playing cards, a first card; determine a roulette value for the first card using mapping data, the mapping data indicating a mapping of card values to roulette values; transmit, to each of the at least one of the plurality of player computing devices, data representative of the first card and the roulette value for the first card; determine the outcome of the game of roulette for each of the plurality of player computing devices, wherein the outcome includes a payout based on the bet received from the respective player computing device of the plurality of player computing devices; and return, to each of the at least one of the plurality of player computing devices, the outcome of the game of roulette.

In some implementations, the embodiments described herein can optionally include one or more of the following features. For example, the electronic gaming system may include a plurality of physical playing cards that are physically dealt by a dealer; a scanner that is configured to identify each of the playing cards as they are dealt by the dealer, wherein the scanner is in communication with the gaming computing device; and a plurality of gaming tables, wherein each of the plurality of gaming tables allows the dealer to deal the physical playing cards, wherein the scanner is configured to read one or more of the physical playing cards for the gaming table. At least one of the plurality of player computing devices may be physically located at at least one of the plurality of gaming tables. At least one of the plurality of player computing devices may be physically remote from a location of at least one of the plurality of gaming tables. The gaming computing device may be configured to deal the playing cards. Each of the at least one of the plurality of player computing devices may be configured to output, in a graphical user interface (GUI) display at the at least one of the plurality of player computing devices, a graphical representation of a roulette table. Each of the at least one of the plurality of player computing devices may be further configured to receive user input selecting a portion of the graphical representation of the roulette table, wherein the user input indicates the bet. The bet may include at least one of a player-selected roulette value, a player-selected pair of roulette values, a player-selected row of roulette values on a graphical representation of a roulette table, a player-selected column of roulette values on the graphical representation of the roulette table, player-selection of each corner of the graphical representation of the roulette table, player-selection of red roulette values on the graphical representation of the roulette table, player-selection of black roulette values on the graphical representation of the roulette table, player-selection of first, second, or third roulette values on the graphical representation of the roulette table, player-selection of a lower half of roulette values on the graphical representation of the roulette table, or player-selection of an upper half of roulette values on the graphical representation of the roulette table. Based on receiving the data representative of the first card and the roulette value for the first card, each of the at least one of the plurality of player computing devices may be configured to output, in a GUI display at the at least one of the plurality of player computing devices, a graphical representation of the first card with the roulette value overlaying a portion of the graphical representation of the first card. The roulette value may be displayed in a center portion of the graphical representation of the first card and an actual value of the first card is displayed in first and second corners of the graphical representation of the first card. The playing cards may be physical playing cards and the gaming computing device is configured to translate the first set of playing cards into a first set of electronic cards. The first card may be a first card in a card sequence in the first set of playing cards. The first set of playing cards may be a set of five playing cards, and the gaming computing device may be configured to discard second, third, fourth, and fifth cards in the card sequence in the first set of playing cards. Identifying, among the first set of playing cards, a first card may include identifying the first card in a card sequence of the first set of playing cards having a card value that is mapped to a roulette value in the mapping data. In response to determining that none of the cards in the first set of playing cards have a card value that is mapped to a roulette value in the mapping data, the system may be configured to perform operations including identifying a second set of playing cards among the plurality of sets of playing cards being continuously identified; identifying, among the second set of playing cards, a first card; determining a roulette value for the first card in the second set of playing cards based on the mapping data; transmitting, to each of the at least one of the plurality of player computing devices, data representative of the first card in the second set of playing cards and the roulette value for the first card in the second set of playing cards; and determining the outcome of the game of roulette for the based at least in part on the roulette value for the first card in the second set of playing cards. The first set of playing cards may be different than the second set of playing cards. The first card may be identified among the first set of playing cards based on one or more card identification rules. The outcome of the game of roulette may be determined based at least in part on one or more rules for playing a game of roulette. The gaming computing device may be further configured to receive, from at least one of the at least one of the plurality of player computing devices, data representative of a side bet; and determine one or more game outcomes for the at least one of the at least one of the plurality of player computing devices based on the side bet. Sometimes, the gaming computing device can further be configured to provide, in GUI displays of the at least one of the plurality of player computing devices, selectable options to play multiple different games simultaneously with the plurality of sets of playing cards that are being continuously identified.

The devices, system, and techniques described herein may provide one or more of the following advantages. For example, the disclosed techniques reduce costs of labor to operate casinos and other gaming environments. Since the disclosed technology allows for continuously dealing for multiple games from one set of cards (e.g., by a dealer at a gaming table and/or by a gaming computing system), less human labor is required to operate the multiple games. One dealer, for example, can deal for and monitor multiple games at once from one gaming table and/or one gaming computing system. Less human labor involved can also improve efficiency and accuracy of gameplay in the multiple games and different types of games by reducing potential human error in determining gaming outcomes and gaming rules for the different types of games that may be played by players at a gaming table or remote from a physical location of the table. Less human labor involved can also reduce training or other onboarding costs for the casinos or other gaming environments that employ the disclosed technology.

Similarly, the disclosed technology also improves payout accuracy by reducing human error. In various betting games, payout schemes can be different and/or challenging to memorize and learn for a human dealer. The digital payout format of the disclosed technology avoids time, resources, and cost of training human dealers to learn all the rules of various different games and their respective payout schemes. This improves accuracy of game dealing, outcome, and payout decisions.

As another example, the disclosed technology provides increased game offerings to players. Players can play a variety of different games from their single player computing device, regardless of whether there are sufficient resources (e.g., gameplay space, chip sets) to offer a full-sized game at a gaming table. The players can play the variety of games simultaneously, by toggling between graphical user interface (GUI) displays presented at their respective player computing devices during gameplay. The GUI displays can provide easy, interactive, and user-friendly experiences that encourage the players to play multiple games at once.

Table-based card games can therefore be provided to a large number of players from a single table. Traditional table games have a limited number of seats available for players. In contrast, electronic gaming systems that use common cards that are being continuously dealt can allow participation of players at the physical table where the cards are being dealt as well as players who are remote from the table and/or connected to the table virtually, and allow players to participate in the game, and different types of games, at different times and play at different paces. This can expand the number of players (beyond just those seated at the physical table) for a single table to include a large number of players who may be playing remotely from a location within a gaming environment (e.g., casino, card club, race track) and/or over the internet. Additionally, the number of players can be expanded without concern for the ratio of players to remaining cards in a deck/shoe. Using the disclosed technology to reduce resources, both physical (in terms of cards and dealer time to deal out each hand) and electronic (in terms of computing resources used to process game play, such as processor cycles, memory, network traffic, etc.), can make gameplay more efficient and faster. Additionally, even though the disclosed technology provides greater efficiencies, it still permits each player to individually make moves (e.g., place bets, start new games, play multiple games at once) regardless of whether they are seated at the physical table or remote, which can improve player engagement while maintaining gaming efficiencies.

The disclosed technology provides for simultaneously managing each player's gameplay in the variety of different games in real-time, such as based on timing at which they take action(s) in each game, gaming rules, gaming outcomes, payout determinations, betting actions, side betting actions, etc. The disclosed technology is able to manage such gameplay not only for any quantity of games played by a single player, but also any quantity of games being played by any quantity of players, including players who are physically located in a casino or gaming environment and players that are remote from such location(s) but playing the variety of different games remotely at their respective player computing devices. Consequently, more players can play games without being constrained by physical limitations of casinos, other gaming environments, and/or specific game-based limitations (e.g., a number of players who can play a particular game, a number of players who can sit at a physical gaming table).

Likewise, the disclosed technology provides for players to play at their own paces without compromising any player's gameplay. A dealer can continuously deal physical cards at a table at different time intervals. Players, both at the table and remote from the table, can perform actions on their hands, such as placing bets or starting new/additional games, at different times, and the dealer at the table does not have to wait for all the players to perform the actions to move on to a next stage of gameplay. When a player performs an action such as placing a bet in a game of roulette, a request can be transmitted to the dealer's computing system for a determination of whether the player wins the bet based on the card that is selected for being mapped to a roulette value. The dealer's computing system can make this determination at a same or similar time as a time of the request. Thus, a fast player may not be held up waiting for a determination of whether they win their bet because of a slower player at the table or remote from the table. Each player can play at their desired paces, regardless of the paces of other players.

Similarly, the disclosed technology provides for higher earn rate per table per day in a gaming environment. Since multiple games are offered with a same dealer at a gaming table, a frequency of players at that table playing games, whether the players are physically present or physically remote at the table, increases. Higher frequency of play increases an amount of money cycling through the table, thereby improving profits on the house.

In another example, by using common cards instead of individual cards, a number of cards that are used for multiple players can be decreased, which can create greater efficiencies, increase the number of players that are able to be played per shoe, and decrease the amount of time that is spent switching between/shuffling shoes. Thus, the amount of time taken away from game play (due to shoe shuffling/replacement) can be reduced, the electronic and physical resources that are allocated per player can be reduced, and the amount of time dedicated to game play can be increased.

As another example, electronic roulette gaming can be provided in jurisdictions (e.g., cities, counties, states, countries) that prohibit gaming outcomes based on random number generators and pseudo-random number generators. Electronic roulette gaming, like electronic roulette equipment, may rely on computer-based random number generators and pseudo-random number generators to electronically determine where a ball lands on a virtual roulette wheel. Some jurisdictions prohibit the use of random and pseudo-random number generators to determine gaming action and outcomes-meaning that in those jurisdictions, conventional electronic roulette gaming is prohibited in gaming environments. By providing roulette with common cards that are continuously dealt with dealer-assist electronic gaming systems and then converted to roulette values, electronic roulette gaming can be provided to players in these jurisdictions that prohibit random and pseudo-random number generators because the gaming action and outcomes are determined by physical cards that are physically dealt by a dealer.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-B are conceptual diagrams of an example card-based electronic roulette gaming system.

FIGS. 2A-B are conceptual diagrams of an example card-based electronic gaming system that can be used for the roulette game of FIGS. 1A-B.

FIG. 2C is a conceptual diagram of timing for example gameplay with the card-based electronic gaming system of FIGS. 1A-B and 2A-B.

FIG. 3 depicts example gameplay using cards that are continuously dealt with an example card-based electronic roulette gaming system.

FIG. 4 depicts an example grid of continuously dealt playing cards.

FIG. 5 is a flowchart of an example technique for performing card-based electronic roulette gaming.

FIG. 6 is a flowchart of another example technique for determining gaming outcomes for multiple games that are simultaneously played as cards are being continuously dealt.

FIGS. 7A-C are flowcharts of example techniques for transmitting sets of cards to player computing devices.

FIG. 8 is a schematic diagram that shows an example of a computing device and a mobile computing device.

Like reference symbols in the various drawings indicate like elements.

### DETAILED DESCRIPTION OF ILLUSTRATIVE EMBODIMENTS

This document relates to electronic gaming systems and continuous progression of gameplay regardless of pacing and/or stages of gameplay of each player at a physical gaming table or remote from the gaming table. Although the disclosed technology is described in reference to roulette games, the disclosed technology is also applicable to a variety of other types of games provided by electronic gaming systems, including but not limited to five-card draw poker games, baccarat, and craps. When multiple players are involved, each player can play a game at different paces. For example, some players can leave the game and come back to it at a later time. Other players can focus only on one game and can make quick gameplay decisions that cause them to play the game relatively faster than other players. The disclosed technology provides for allowing players to play at their desired paces without being slowed down or pressured to play faster by other players. As described herein, a dealer can continuously deal sets of cards that can be ready the moment they are dealt to be transmitted to electronic gaming equipment of one or more players. For example, some players can start a game of roulette at the same time and can all receive a same roulette value that is mapped to a card in a set of cards that is dealt within a threshold amount of time of starting the game. In another game, a first player can place a bet within a first period of time and a second player can take longer and place a bet within a second period of time. The electronic gaming system can identify a card that is mapped to a roulette value in a set of cards dealt at the first time for the first player and a card that is mapped to a roulette value in a set of cards dealt at the second time for the second player. Therefore, the first and second players can play roulette at their desired paces and not have their gameplay affected by the gameplay and pacing of the other player.

Moreover, the gaming systems described herein can allow players to play side bets. The players can place side bets on top of existing wagers or bets that they placed. For example, several types of side bets can be added to a roulette game that is primarily described therein. Side bets can be implemented for cards that do not map to roulette values. Other side bets can also be placed. As an illustrative example, players can bet that a first card in a card sequence of a set of cards will be a face card, a second card in the card sequence will be a black 10, a third card in the card sequence will be a Spade face card, a fourth card in the card sequence will be a Queen, and a fifth card in the card sequence will be a black Queen. A variety of other side bets can be placed by the players in a game of roulette.

In addition, the gaming systems described herein can allow players to tip dealers to reimburse or otherwise reward the dealers for a positive gaming experience. For example, the players can make straight donations to the dealers using one or more options that are presented on player computing devices. The players can also tip the dealers in the form of betting for the dealer, along with the players' hands.

This document describes a variety of different features, which can be selected and incorporated into gaming systems and equipment in various combinations. For example, different jurisdictions can have different gaming regulations outlining gaming features that are permitted within the jurisdictions. Features that are compliant with the gaming regulations for a jurisdiction can be implemented (e.g., activated, included) in gaming systems and equipment deployed in that jurisdiction, and other features that are not permitted within the jurisdiction can be deactivated/not included.

The disclosed technology is described herein as applying to card-based electronic roulette games. A traditional roulette wheel consists of 36 numbers, half red and half black. Traditional roulette tables have 1, 2, and sometimes 3 additional numbers, which include 0, 00, and 000. Roulette tables with 00 may be common, thereby resulting in total possible draw combinations (in lieu of roulette wheel spins) of 38. Other combinations are also possible, depending on roulette implementation (37 combinations if the roulette table has 0 and 39 combinations if the roulette table has 000). The disclosed technology provides for automating traditional roulette gameplay with sets of continuously dealt cards, rather than spinning of a virtual roulette wheel. In some implementations, in a standard set of 52 cards, face cards can be considered non-value cards, thereby resulting in 40 cards to be assigned to roulette values. As an illustrative example, black 10′s can be identified as non-value cards so that 38 cards result for 38 possible draw combinations. One or more other rules can be defined and used to determine which cards are assigned roulette values and which cards are non-value cards. In the illustrative example presented herein, to maintain a red/black balance of traditional roulette games, 10 of Diamonds and 10 of Hearts can be considered 0 and 00, respectively. 36 cards remain, half red and half black, all of which can be mapped to 36 roulette values on the traditional roulette wheel. As mentioned above, various other rules and mappings can be employed to associate card values with roulette values on the traditional roulette wheel.

A roulette table can be presented at computing devices of players, who may play the same or different games at their desired paces and/or from their desired locations (e.g., physically at a table where the dealer is dealing the cards or physically remote from the table or a gaming environment/facility having the table). The players can place bets through their computing devices by selecting portions of the virtual roulette table as if they are placing bets on a standard, physical roulette table. The players can place various types of bets known in roulette as well as side bets. For example, the players can place bets straight up on a number, a pair of numbers, a row or column of numbers, four corners, red/black, 1^{st}, 2^{nd}, or 3^{rd} 12, lower half, and/or high half of a field on the roulette table. The bets can be placed within a threshold amount of time. Once the threshold amount of time expires, the gaming system can identify a set of cards that was dealt within the threshold amount of time. Amongst cards in the identified set of cards, the gaming system can identify a first card that is mapped to a roulette value. That card can be displayed at the player's computing devices along with the mapped roulette value. Any bet that would pay in a traditional game of roulette for the mapped roulette value can also be automatically paid out using the disclosed technology. If none of the cards in the identified set of cards are mapped to a roulette value, then the gaming system can identify a next set of cards that were dealt and use the next set of cards to reconcile the bets.

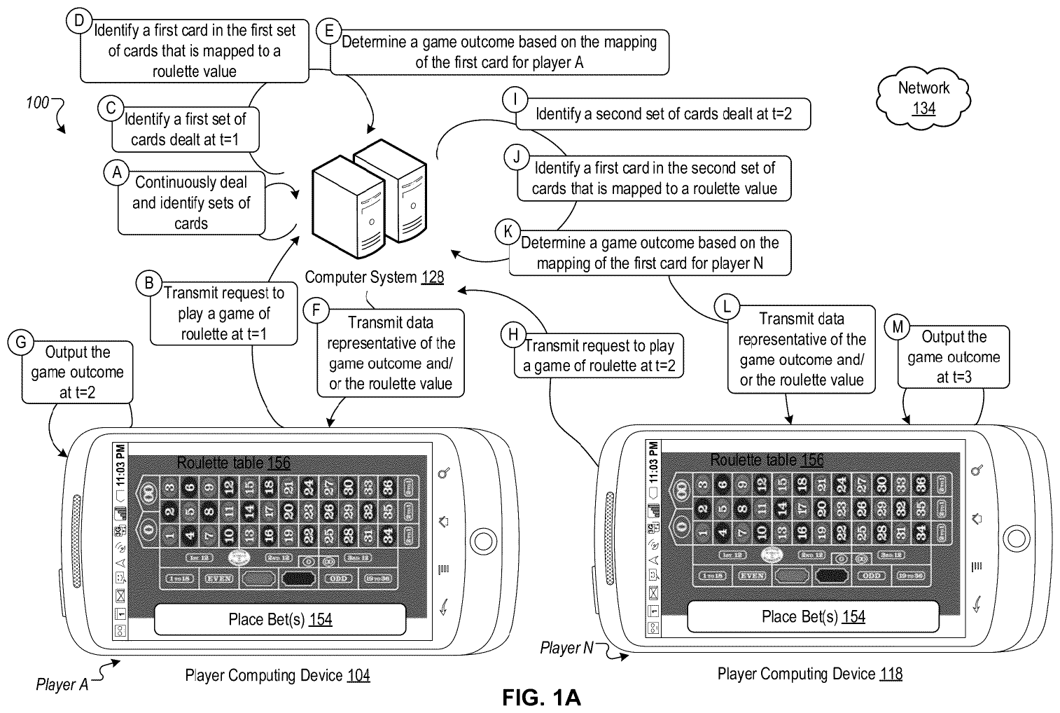

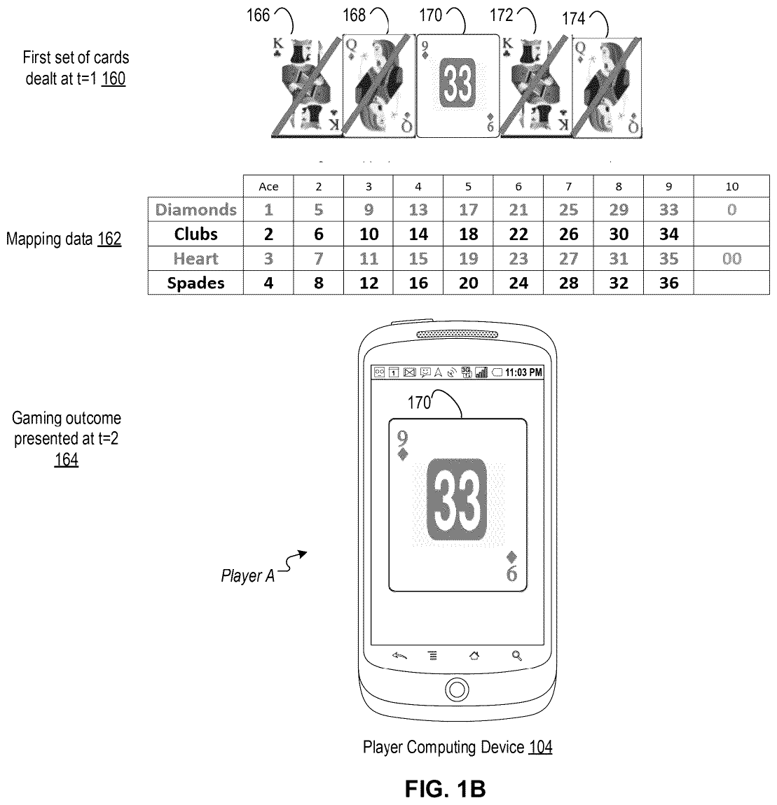

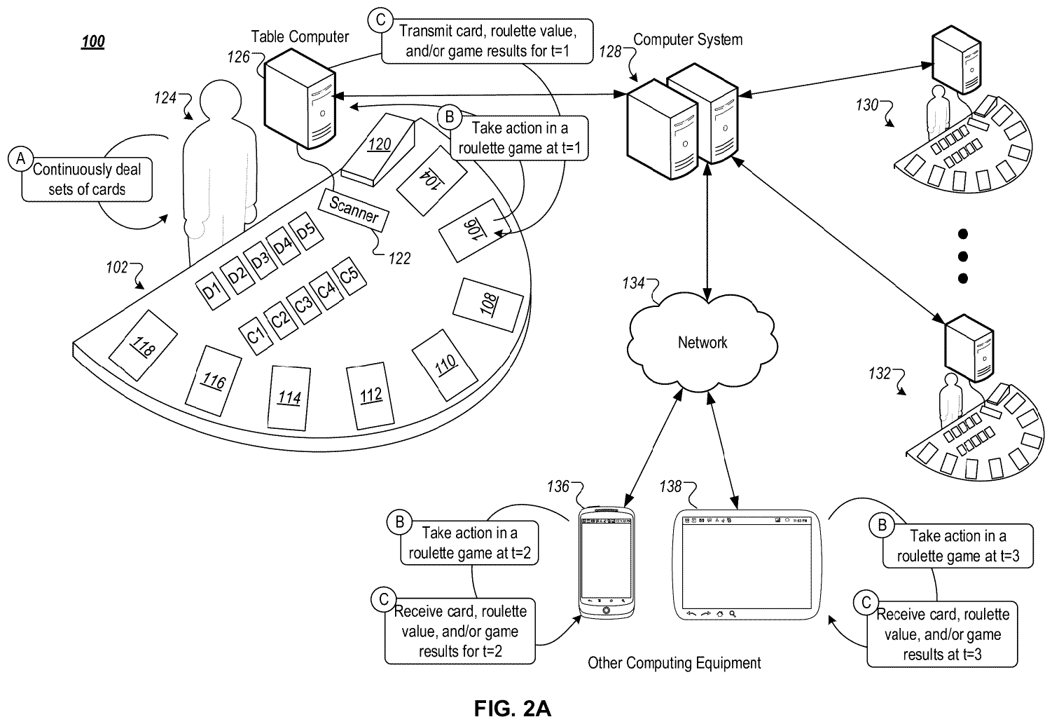

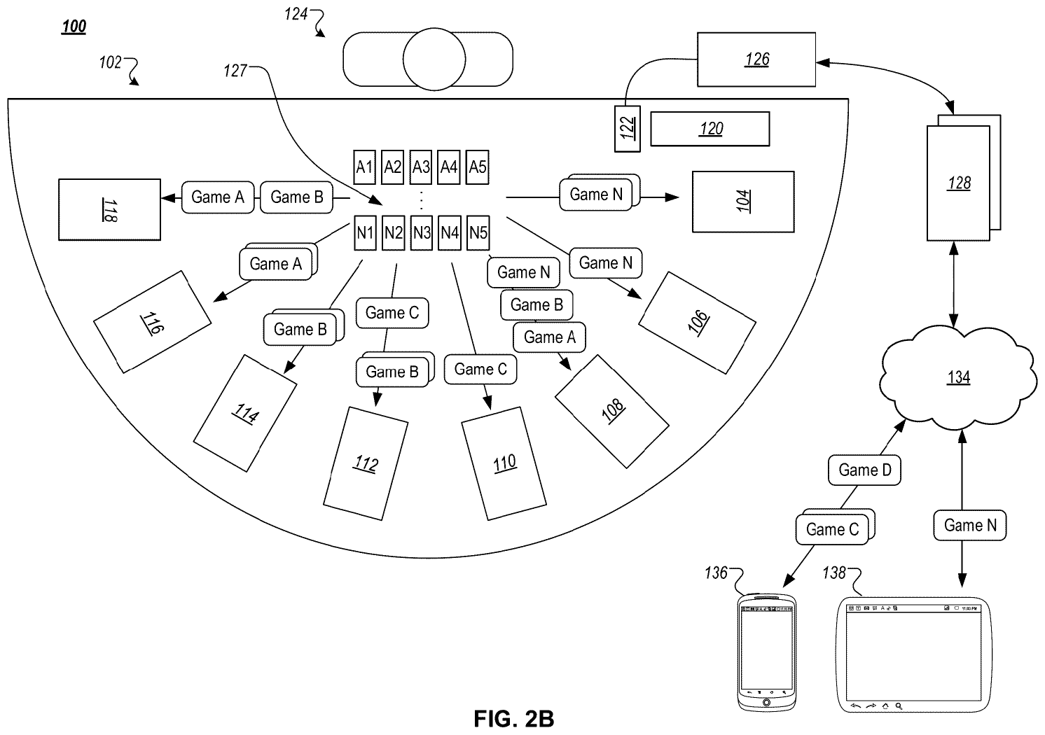

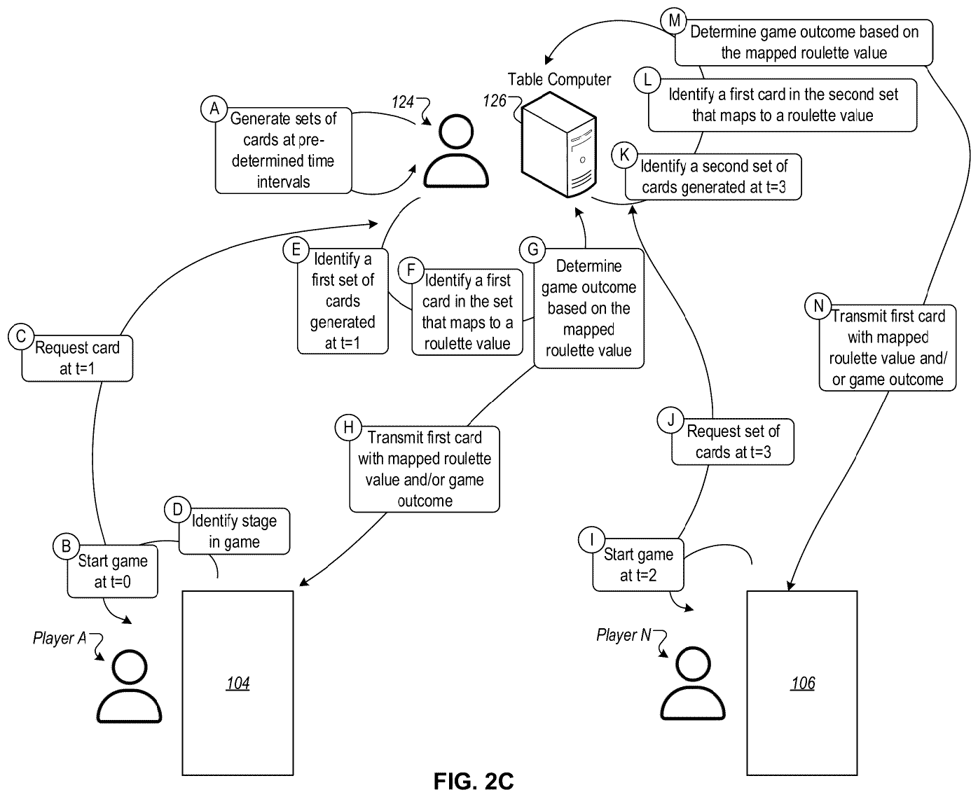

Referring to the figures, FIGS. 1A-B are conceptual diagrams of an example card-based electronic roulette gaming system 100. A computer system 128 and player computing devices 104 and 118 can communicate (e.g., wired and/or wireless) via network 134. In some implementations, the computer system 128 can be a table computer, such as a table computer at a physical gaming table in a casino or other gaming environment. In some implementations, one or more of the player computing devices 104 and 118 may be part of or at the physical gaming table. At least one of the player computing devices 104 and 118 may be physically within the same casino or gaming environment as the physical gaming table and/or physically remote from the location of the casino, gaming environment, or physical gaming table. Moreover, any number of players can play a game of roulette from their respective player computing devices. Refer to FIGS. 2A-C for further discussion about the components of the electronic gaming system 100.

The computer system 128 can be configured to provide card-based electronic roulette gaming, as well as other gaming, to the player computing devices 104 and 118. The computer system 128 can continuously deal sets of cards (e.g., electronic cards, physical cards dealt by a dealer and scanned by a scanner), map the dealt cards to roulette values on a roulette wheel, and determine gaming outcomes based on bets placed by players and a card in a set of dealt cards that is mapped to a roulette value. As described below in reference to FIGS. 2A-B, a table computer at a physical gaming table where the physical cards may be dealt by a dealer can also be configured to perform the operations performed by the computer system 128 as described in FIGS. 1A-B.

Referring to FIG. 1A, the computer system 128 can continuously deal and identify sets of cards (block A). Described further below, the cards can be physical cards that are continuously dealt by a dealer, such as a human dealer and/or a robot/machine dealer, scanned, and then translated into electronic cards having card values corresponding to the actual card values on the physical cards. Sometimes, the cards can be electronic cards and the computer system 128 can continuously deal and identify the sets of electronic cards in block A. Each set of cards can include 5 cards. Each set of cards can also include a timestamp indicating a time at which the set of cards was dealt and/or identified. The timestamp can be used to determine which set of cards to use, by the computer system 128, in response to an action or request made at the player computing devices 104 and 118. The sets of cards can be used for a variety of different games offered at the player computing devices 104 and 118, including but not limited to baccarat, five-card draw poker, other poker games, roulette, and craps.

In block B, at time t=1, the player computing device 104 can transmit a request to the computer system 128 to play a game of roulette. The request may include one or more bets that player A places on a roulette table 156 presented in a graphical user interface (GUI) display at their player computing device 104. The player A can place the bet(s) by selecting or tapping on one or more portions of the roulette table 156, similarly to how the player A would place the bet(s) on a traditional, physical roulette table in which the player A would place their chips on one or more portions of the table. Additionally or alternatively, the player A can place bets by selecting a graphical element 154 presented at the player computing device 104. The graphical element 154 can be a button.

In some implementations, the player A can only place bets during a threshold period of time. The threshold period of time can be determined according to known roulette gaming rules. For example, the threshold period of time can correspond to a predetermined amount of time in which, in a traditional game of roulette, a ball will be dropped into a spinning roulette wheel. Once the threshold period of time ends, the player A can no longer place bets on the current game of roulette. In electronic roulette gaming, the player A can place bets during a next threshold period of time, for example at time t=2, which would correspond to a roulette value mapped to a card that is dealt at or around (e.g., within a threshold amount of time) the time t=2.

The computer system 128 can identify a first set of cards that are dealt at time t=1 in block C. The first set of cards can be a set of cards that was dealt (block A) at the time of the request, t=1. The first set of cards can also be identified based on having been dealt within a threshold amount of time of a last bet placed by the player A. The first set of cards may be identified based on having been dealt at a same time as a time that the player A placed the last bet. The first set of cards can also be identified using one or more other threshold amounts of time from the time of the request, t=1, as described further below.

From the first set of cards, the computer system 128 identifies a first card that is mapped to a roulette value (block D). For the game of roulette, the computer system 128 can identify a first card in a card sequence of the first set of cards that corresponds to a roulette value. As described above, mapping rules can be defined to map each card value in a standard 52-card deck to a roulette number between 0 and 36, and optionally additional roulette values, such as 0, 00, and 000. Therefore, if the first card in the card sequence of the first set of cards has a card value that, according to the mapping rules/data, is associated with a roulette value, then the computer system 128 can identify that card as the first card in block D. As another example, if the 5^{th} card in the card sequence of the first set of cards is the first card in the entire set to have a card value that is associated with a roulette value, then the computer system 128 can identify the fifth card in block D. As yet another example, if none of the cards in the card sequence of the first set of cards has a card value that is associated with a roulette value, then the computer system 128 can identify a second set of cards that were dealt and perform block D on the second set of cards. The second set of cards can be a set of cards that was dealt immediately after the first set of cards. The second set of cards can also be a set of cards that was dealt a threshold amount of time after the first set of cards having been dealt.

The computer system 128 can determine a game outcome based on the mapping of the first card for the player A (block E). In other words, the computer system 128 can apply one or more known roulette gaming rules to determine whether the player A has won the bet(s) they placed at time t=1 based on the resulting roulette value. The resulting roulette value, as described above, is the roulette value that is mapped to a card value of the first card identified in block D. The computer system 128 can also determine a payout for the player N and/or automatically settle the player A's bets/wagers in block E.

In block F, the computer system 128 can transmit, to the player computing device 104, data representative of the game outcome and/or the identified first card with its corresponding roulette value. Sometimes, the computer system 128 can transmit data representative of the identified first card with its corresponding roulette value at a first time and then transmit data representative of the game outcome at a second time. The first time can be before the second time. The first time can be, for example, before the computer system 128 determines the game outcome in block E. The second time can then be after the computer system 128 determines the game outcome in block E.

The player computing device 104 can output the game outcome and/or the identified first card with its corresponding roulette value in a GUI display (block G). This information can be outputted at the player computing device 104 at time t=2, or any other time after the time t=1. Refer to FIG. 1B for further discussion about the information that can be outputted at the player computing device 104.

Although not depicted in FIG. 1A, the player computing device 104 can also output results that include whether the player A won their bet(s), a payout, and/or betting options to play another game of roulette.

Similar to the blocks B-G, blocks H-M can be performed with regards to the player computing device 118 or any other player computing device or computing equipment described herein. For example, player N at the player computing device 118 can transmit a request to play a game of roulette at time t=2 (block H). The request can include one or more bets placed by player N within some threshold amount of time. As an illustrative example, player A and player N can start the game of roulette at the same time t=0. The player A can be a faster player, and may provide their bets at t=1, within a designated threshold amount of time. As a result, the computer system 128 can use cards that were dealt at t=1 to determine a roulette value and game outcome for the player A. Since the player N is a slower player, the player N may not provide their bets until t=2, which is after the designated threshold amount of time for placing bets. As a result, the computer system 128 can use cards that were dealt at t=2 to determine a roulette value and game outcome for the player N. Time t=2 can be any time after time t=1. As a result, and as described above, different sets of cards are used to determine a roulette value and game outcome for the players A and N due to their different pacing of gameplay.

Once the computer system 128 receives the request in block H, the computer system 128 can identify a second set of cards dealt at or around/within a threshold amount of time of the time t=2 (block I). The computer system 128 can then identify a first card in the second set of cards that is mapped to a roulette value (block J), as described in reference to block D. The computer system 128 determines a game outcome based on the mapping of the card identified in block J for the player N (block K). Refer to block E for further discussion. Then, the computer system 128 can transmit data representative of the game outcome and/or the roulette value to the player computing device 118 (block L), and the player computing device 118 can output at least the game outcome at t=3 (block M). Refer to blocks F-G for further discussion.

Referring to FIG. 1B, the first set of cards 160 dealt at time t=1, as described in reference to blocks A and C in FIG. 1A, can include cards 166, 168, 170, 172, and 174. In this illustrative example, card 166 is a King of Clubs, card 168 is a Queen of Diamonds, card 170 is a red 9 of Diamonds, card 172 is a King of Clubs, and card 174 is a Queen of Diamonds. The computer system 128 can use mapping data 162 to identify which, if any of the cards 166-174 in the first set of cards 160 is mapped to roulette values. The mapping data 162 shown in FIG. 1B is merely illustrative, and any other mapping data and/or mapping rules can be used in other implementations of the electronic gaming systems described herein.

As an illustrative example of the mapping data 162, face cards may be non-value cards. As a result, the computer system 128 can discard the cards 166, 168, 172, and 174. The card 170 is the first card in the card sequence of the first set of cards 160 that is mapped to a roulette value, as shown by the mapping data 162. As a result, the computer system 128 can identify the card 170 as having a roulette value for the player A's current game of roulette.

At time t=2, a gaming outcome 164 can be presented at the player computing device 104 of the player A. The gaming outcome 164 can include a visual representation of the card 170. The card 170 can be presented with its actual card value in at least one corner of the card 170. Here, the red 9 of Diamonds is depicted in a top left corner and a bottom right corner of the card 170 at the player computing device 104. The card 170 can also be presented with its corresponding roulette value in a center portion of the card 170. In this example, the card 170's value corresponds to the roulette value of 33, according to the mapping data 162. Although not shown in FIG. 1B, a payout for the player A can be automatically determined by the computer system 128 and optionally outputted in the GUI display of the player computing device 104.

FIGS. 2A-B are conceptual diagrams of an example card-based electronic gaming system 100 that can be used for the roulette game of FIGS. 1A-B. As shown in FIG. 2A, the system 100 includes an example gaming table 102 that includes player computer devices 104-118 (e.g., touchscreens, electronic screens or displays) that are located at each of the positions for the table 102. The table 102 also includes a scanner 122 that is configured to automatically detect cards that are dealt out of the shoe 120 by a dealer 124. In some implementations, the scanner 122 can also be configured to automatically detect cards that are dealt out of the shoe 120 by a robot dealer, a table computer 126, or another computing system, such as the computer system 128, described above in reference to FIGS. 1A-B.

The scanner 122 can be implemented in any of a variety of ways, such as an optical scanner that is configured to detect each card that is dealt from the shoe 120 through optical recognition of one or more unique portions of the cards (e.g., image recognition techniques to identify the suit and number for each card and/or to identify a code printed on each card, such as a barcode or QR code), radio frequency-based identification (e.g., recognition of RFID tags included in each card), and/or other identification techniques. The scanner 122 can be a barcode scanner, QR code scanner, camera (e.g., overhead camera(s) over the table 102), other optical scanner, RFID reader, or other radio frequency scanner that can accurately detect physical playing cards that are dealt by the dealer 124 (e.g., a human or a robot at a physical gaming table) and to use those dealt cards to provide electronic gaming outcomes to players. Gaming systems that use any of a variety of card scanners to obtain physical card information may be referred to as “dealer assist” gaming systems. In some implementations, the cards that are dealt out of the shoe 120 are specialized playing cards with one or more features (e.g., codes, RFID tags) that are specifically designed for detection by the scanner 122. In other implementations, the cards that are dealt out of the shoe 120 are standard playing cards without specially designed features.

Card-based electronic roulette gaming is provided at the table 102 through the use of table computer system 126 that, in combination with the scanner 122, detects the cards that are dealt from the shoe 120 by the dealer 124 (which can be a human, robot, or other mechanical dealing equipment/machine), manages gaming information and interactions through the player computer devices 104-118, and determines gaming outcomes based on the cards that are dealt and the player actions (as designated through the devices 104-118). The shoe 120 can store one or more decks of physical playing cards that are ordered within the shoe 120 through physical shuffling of the cards (e.g., machine shuffling, manual shuffling, or a combination thereof). Through these collective parts (table 102, table computer system 126, scanner 122, shoe 120, dealer 124, devices 104-118), the system 100 can provide dealer assist electronic gaming to players through the use of physical cards, including games such as roulette. The system 100 can also simultaneously provide a variety of different dealer assist electronic games, including but not limited to electronic five-card draw poker gaming.

Sometimes, the table computer system 126 is programmed to use common cards to provide roulette gaming across the players through the devices 104-118. Sometimes, only some of the devices 104-118 can be occupied by players. Further, the players can join the game at different times before or while the cards are being dealt by the dealer 124 at the table 102, as described further in reference to FIG. 1A. Players at each of the occupied player computing devices can select selectable options presented at their devices to perform player actions. For example, the players can select graphical elements representing buttons to place one or more bets in a game of roulette. The players can also select portions of a graphical representation of a roulette table to play their bets. In another example, the devices 104-118 can include physical buttons corresponding to different type of gaming actions that can be taken in a game of roulette. Player actions can be maintained locally on the devices 104-118 and/or can be transmitted to the table computer system 126.

The dealer 124 can continuously deal sets of cards, one example of which is a set of cards D1-D5 (block A). The dealer 124 can deal cards at a particular interval, for example, every 5 seconds, 10 seconds, 15 seconds, 20 seconds, 30 seconds, etc. Since the dealer 124 is continuously dealing cards, whenever one of the players requests to play a game, they can immediately receive a roulette value that is mapped to a card that was dealt at a same time or similar time as a time of the request/a bet (e.g., a time shortly after the time of the request). The players can continue to play the game at their desired paces, without being slowed down by gameplay pacing of other players. 5 cards, such as the cards C1-C5, can be exposed, and the cards can continuously be shuffled into decks. Multiple players can then play off the same 5 cards at their desired paces. As a result, an entire process of the game may not be slowed down. Moreover, fast players may not have to wait for slower players to take gaming actions. Furthermore, the odds can become different since all the cards except for the 5 exposed cards are continuously being shuffled and transmitted to players based on times at which they request sets of cards (e.g., start a game, place bets). Continuous shuffling and dealing can therefore mitigate risk that multiple players may win with the same cards.

Since the dealer 124 is continuously shuffling and dealing sets of cards, players can join a game at any moment. The new player can receive a roulette value corresponding to a card that was dealt at a time at which the player joins the game. Another player might have started the game earlier but did not place bets until the new player joined the game. As a result, the another player and the new player can receive the same roulette value.

The table computer system 126 and/or the player devices 104-118 can determine the outcome of the game for each player based on the roulette value derived from the dealt cards, such as cards C1-C5, the player's actions (e.g., bets, side bets), and one or more roulette gaming rules. The cards C1-C5 and D1-D5 can be separately dealt sets of cards. In some implementations, only one set of currently dealt cards (e.g., D1-D5) can be presented on the table 102 and a previously dealt set of cards (e.g., C1-C5) can be discarded or otherwise moved aside from the table 102. In some implementations, the table computer system 126 (in combination with the central computer system 128 described above) can determine and manage gaming at each of the positions, and can simply use the devices 104-118 to present information to the players and to obtain player inputs (e.g., discard selections, bet amounts). In other implementations, each of the devices 104-118 can manage an individual player's gaming and can communicate with the table computer system 126 to receive card information. Other implementations are also possible.

The system 100 can additionally incorporate and permit remote players to play roulette on the table 102, such as through other computing equipment 136 and 138 (e.g., smartphones, tablet computers, wearable computing equipment (e.g., smart watches), desktop computers, laptop computers, media computers, virtual reality systems, augmented reality systems). For example, the system 100 can use the central computer system 128 to connect remote players with the table computer system 126 so that remote players can additionally participate in roulette gaming on the table 102. Such remote players may be located in the same facility as the table 102 (e.g., casino, card club, horse track) and/or remote from such a facility (e.g., located remotely, at home). Via the equipment 136 and 138, the remote players can connect to the computer system 128 and the table computer system 126 to participate in roulette gaming at the table 102 and/or other tables 130-132 over one or more networks 134, such as the internet, local area networks (LAN), wide area networks (WAN), virtual private networks (VPN), mobile data networks (e.g., 4G LTE networks), wireless networks (e.g., Wi-Fi networks, BLUETOOTH networks), and/or combinations thereof. The remote electronic equipment 136 and 138 can download and run code from the computer system 128 to provide electronic baccarat gaming on the equipment 136 and 138, as described in reference to the computing devices 104-118. Such code can be, for example, a mobile application (“mobile app”) that is downloaded and installed on the computing equipment 136 and 138, a browser-based application that is downloaded and run within a web browser application on the computing equipment 136 and 138, a standalone application that is downloaded and installed on the computing equipment 136 and 138, and/or other types of code and/or applications.

The computer system 128 can additionally allow players, such as local players using devices 104-118 and/or remote players using equipment 136-138, to bounce between gaming at tables 102 and 130-132, to play multiple games or hands simultaneously/concurrently across the tables 102 and/or 130-132, and to even combine common cards from multiple different tables 102 and 130-132 for various bets and/or side bets. For example, a player can press a button requesting that the computer system 128 place him/her in the table that is going to be dealing next, so as to allow the player to minimize wait time. The computer system 128 can automatically transfer such a player to a table that is the first to scan cards for a roulette value, and can present the roulette value from that table to the player, even though the player may be located at another table or remote from the table. In a further example, a player may be permitted to concurrently play multiple hands or games across the tables 102 and/or 130-132. Additionally, the computer system 128 may perform load balancing of players so as to more evenly distribute players across the tables 102 and 130-132.

The computer system 128 can additionally distribute video, audio, and/or chat feeds for the tables 102 and 130-132 to remote players using the computing equipment 136-138.

Still referring to FIG. 2A, the dealer 124 can continuously deal sets of cards in block A. For example, as soon as at least one player joins a game, the dealer 124 can start to deal sets of cards and continue to deal sets of cards until all the players are done, the game has ended, or some input is received that indicates an end of gameplay. The dealer 124 can deal cards at a dealer-desired pace (e.g., as quickly as the dealer 124 can shuffle and deal sets of cards and/or at timed intervals, as described above). The dealt cards can be scanned by the scanner 122. Once scanned, the dealt cards are ready to be transmitted to any of the devices 104-118 and/or the other player computing equipment 136-138 when requested by the players. In some implementations, the dealer 124 may wait to deal sets of cards until a first player has joined a game. In some implementations, the dealer 124 may wait to deal sets of cards until one player provides first input at their devices 104-118 and/or computing equipment 136-138. The first input can, for example, be a pause action, a resume action, and/or at least one bet. In yet some implementations, the dealer 124 can continuously deal sets of cards regardless of whether and/or when a player joins a game at the dealer 124's table 102.

Players can take action in a roulette game at time t=1 in block B. For example, the players can place bets on a roulette table presented at their respective devices 104-118. The bets can be placed within a threshold amount of time. Once the threshold amount of time ends, the players can no longer place bets for a roulette value during the current round or stage of gameplay. In other words, the player can place a bet during a subsequent threshold amount of time, during which a new roulette value will be determined from a new set of cards that is being dealt. As described herein, players can provide input at their devices 104-118 and/or computing equipment 136-138 that indicates that they are placing one or more bets, which can be transmitted from the player's computing equipment to the table computer 126 or the computer system 128. Based on this input, the table computer 126 or the computer system 128 can determine a gaming outcome and/or a payout for the particular player.

In block C, the table computer 126 can transmit, to the devices 104-118 and/or 136-138, an identified card, a corresponding roulette value, and/or game results for time t=1. Refer to FIGS. 1A-B for further discussion about identifying a card that maps to a roulette value and determining the game results/outcome.

The table computer 126 can maintain each set of dealt cards with a respective timestamp indicating a time at which the set of cards was dealt and/or scanned by the scanner 122. When an indication of game action (e.g., when a player starts a new game or places a bet) or other input is received from one or more player computing devices 104-118, the table computer 126 can identify a set of dealt cards having a timestamp that is most similar to (e.g., shortly after or shortly before) a timestamp of the indication of game action. Using the identified set, the table computer 126 can then identify a card that is mapped to a roulette value and transmit the identified card to each of the players' computing equipment (e.g., the devices 104-118 and/or the computing equipment 136-138). Sometimes, the identified set of dealt cards can be transmitted to each of the players' computing equipment and the players' computing equipment can then identify which card is mapped to a roulette value.

In some implementations, the table computer 126 can associate times at which physical cards are dealt with times at which such cards are scanned by the scanner 122 and registered by the table computer 126. This can be advantageous to recognize lag and/or relative timing to more accurately determine which sets of cards should be transmitted to which player computing equipment. As a result, players who are physically at the table 102 may not have advantages over online or remote players who cannot see the cards being physically dealt at the table 102. Moreover, online or remote players may not be able to take advantage of the time lag described above to know in advance what next cards will be registered and then transmitted to them.

FIG. 2B is another conceptual diagram of the example card-based electronic gaming system 100. Here, the table computer 126 may use prerecorded sequences of cards that are dealt into grid 127, which may be a virtual grid of cards. The shoe 120 can store one or more decks of physical playing cards that are randomly ordered within the shoe 120 through physical shuffling of the cards (e.g., machine shuffling, manual shuffling, or a combination thereof).

The size and shape (e.g., the number of columns and rows) for grid 127 may vary based on the type of game(s) being offered by system 100 and/or the number of players that can be supported by system 100. The dealer 124 may place each card as dealt from the shoe 120 into the grid 127 based on a particular pattern. For example, a first card may be placed in position A1, a second card may be placed in position A2, and so forth until the grid is filled. As an alternative example, the first card may be placed in position N5, the second card may be placed in position N4, and so forth until the grid is filled. Any number of patterns may be employed to fill the grid 127. The pattern can be switched by the dealer 124 after each grid is used to determine gaming outcomes or after a particular number of grids have been dealt and used. The patterns used for card placement into the grid 127 may be rotated through based on a particular ordering of the patterns. Grid 127 may also be built virtually by the table computer 126 as the cards are dealt by the dealer 124 and read by the scanner 122, or based on a prerecorded dealt sequence of cards.

Through these collective parts (table 102, computing device 126, scanner 122, shoe 120, dealer 124, devices 104-118), the system 100 can provide dealer assist electronic gaming to players through the use of physical cards as dealt into the grid 127, where the gaming outcomes are determined by the random ordering of physical playing cards within the shoe 120 instead of through a random or pseudo-random number generator.

The table computer 126 determines initial and next gaming outcomes for each player computer device 104-118 and remote computer devices/equipment 136-138 based on the cards in grid 127 for both card based and non-card based games. Examples of card based table games include, but are not limited to, Baccarat, Blackjack, Casino war, Faro, Poker and its variants, Red Dog, Teen Patti, and Trente et Quarante. Examples of non-card based table games include, but are not limited to, Roulette, Chuck-a-luck, Craps, Pai Gow, Sic bo, Big Six wheel, Roulette, Fan-Tan, and Two-up. The table computer 126 may employ multiple grids to manage multiple games at the same time or to use one grid from which to select initial hands and another grid from which to select additional or replacement cards.

Similarly to the example in FIG. 2A, the table computer 126 is programmed to use common cards that are continuously dealt to provide electronic gaming to the players through the devices 104-118. For example, the table computer 126 can detect a card that is mapped to a roulette value based on the cards dealt by the dealer 124 and their placement in grid 127. The table computer 126 can transmit information identifying the identified card to the player devices being currently occupied by players (e.g., one, some, or all of the devices 104-118). Each of the occupied player devices, which can be any of a variety of computing devices with an associated display (e.g., tablet computing device, embedded computing device) as described herein, can present the identified card and corresponding roulette value to the players along with selectable options to place bets, wages, or other gaming actions. For example, the devices 104-118 can include touchscreens that present selectable buttons to place a bet before the identified card is presented to the players. In another example, the devices 104-118 can include physical buttons corresponding to different actions that the players can take in a game of roulette. Additionally, multiple games/hands may be displayed by the devices 104-118 to a respective player. Player actions can be maintained locally on the devices 104-118 and/or can be transmitted to the table computer 126.

The dealer 124 may also deal a second grid 127 of cards from which one or more cards that are mapped to roulette values can be selected by the table computer 126. The second grid 127 may be dealt according to the same pattern as the first grid or a different pattern may be used. The table computer 126 may use any variety of rules to identify which card having a mapped roulette value in the card sequence A1-A5 should be assigned and presented to the players at the occupied player devices.

The table computer 126 and/or the player devices 104-118 can determine the outcome of the game for each player based on the card provided from grid 127, which has a corresponding roulette value, the player's actions (e.g., bets), and roulette gaming rules. In some implementations, the table computer 126 (in combination with a central computer system 128) can determine and manage gaming at each of the positions, and can use the devices 104-118 to present information to the players and to obtain player inputs (e.g., bet amounts, side bets). In the depicted example of FIG. 2B, the table computer 126 manages Games A-N for each of the devices 104-118 as well as remote devices 136-138. In other implementations, each of the devices 104-118 can manage an individual player's gaming and can communicate with the table computer 126 to receive card information. Other implementations are also possible.

As described above in reference to FIG. 2A, each of the players at the devices 104-118 can receive sets of cards, cards, or other gaming information for each of the Games A-N based on times at which the players provide input for each game. The dealer 124 can continuously deal sets of cards that are scanned by the scanner 122. The table computer 126 can then receive requests for cards (e.g., requests to start new games) from any of the devices 104-118 and/or the computing equipment 136-138. The table computer 126 can transmit cards that were dealt at times that are the same or similar to the requests for any of the Games A-N that are played at the devices 104-118 and/or the computing equipment 136-138. Thus, continuous gameplay progression can exist for each of the players in each of their Games A-N. The players can continue to play a variety of different games at their desired paces without having to slow down or speed up gameplay to compensate for gameplay paces of other players at the table 102 and/or remote from the table 102.

FIG. 2C is a conceptual diagram of timing for example gameplay with the card-based electronic gaming system of FIGS. 1A-B and 2A-B. Here, 2 players A and N are playing a game at player computer devices 104 and 106, respectively. The dealer 124 continuously generates sets of cards at predetermined time intervals in block A. As described with regards to FIGS. 2A-B, the dealer 124 can continuously deal sets of cards that are scanned by the scanner 122 and transmitted to the table computer 126. The players A and N may play one or more games at different paces. A first group of players, for example, who play at a same pace can receive the same roulette value that corresponds to a card that was dealt by the dealer 124 at a first time. A second group of players can play games at another pace and therefore receive a different roulette value that corresponds to a card that was dealt by the dealer 124 at a second time. Although each of the groups may receive different roulette values from the same dealer 124, one or more of the second group of players may still play the same games as one or more of the players in the first group, albeit at different paces.

Sometimes, first and second players can start a game of roulette together but then continue the game at different paces. For example, a second player can be slower in gameplay than a first player (e.g., the second player can step away from their computing device for some period of time, they may be switching between playing different games). The second player can then receive a roulette value from a different set of dealt cards than the first player, who started the game at the same time but plays the game quicker. The first player may receive a roulette value that corresponds to a card that was dealt before the card that was used to assign roulette value for the second player's gameplay.

With regards to player A in FIG. 2C, player A can start the game, such as a game of roulette, at time t=0 in block B. The player A can start the game before or during a time at which the dealer 124 is dealing the sets of cards. Starting the game can include the player A performing some action or providing some user input at the device 104 that indicates the player A is ready to play the game. For example, the player A can select an option at the device 104 to begin a new game, to resume a game, to select a game to play, or to take some action (e.g., place one or more bets) in a game.

Player A can request a set of cards at time t=1 in block C. The player A can, for example, select an option to start a new game and/or place a bet. This user input can be transmitted to the table computer 126 in block C. The request can include a timestamp indicating a time at which the player A requests to play the game and/or place the bet(s). Sometimes, the timestamp can indicate the time at which the player A begins the game (e.g., t=0) instead of the time at which the request is transmitted to the table computer 126 (e.g., t=1).

Sometimes, time t=1 can be the same time as time t=0. For example, when the player A selects an option to begin a new game at the device 104, the device 104 can immediately/automatically transmit the request to the table computer 126. Sometimes, time t=1 can be the same, earlier, or later than a time at which the dealer 124 begins dealing cards or otherwise is currently dealing sets of cards in block A. Thus, the dealer 124 can already be dealing sets of cards at time t=1. In other implementations, the dealer 124 may not begin to deal sets of cards until time t=1, when the request for the set of cards is first received from the device 104 of the player A.

The device 104 can sometimes identify what stage the player A is currently at in the game in block D. The device 104 can make this identification before, during, or after requesting the set of cards in block C. Moreover, sometimes, the device 104 can make this identification instead of the table computer 126 in order to more efficiently utilize computing resources and to avoid clogging resources of the table computer 126. An indication of the stage of gameplay can also be transmitted, by the device 104, to the table computer 126. The table computer 126 can use the stage of gameplay to identify a roulette value mapped to a dealt card and/or determine game outcomes for the player A.

For example, in block D, the device 104 can determine whether the player A is at an initial stage in which the player A has just started the game and is not yet ready to place bets. The device 104 can also determine whether the player A is at betting stage in the game in which the player A can place one or more bets during a threshold period of time. The device 104 can also determine whether the player A is at a final stage of the game, in which gaming outcomes, payouts, and/or options to start a new game are to be determined by the table computer 126 and presented to the player A at their respective computing device 104.

In block E, the table computer 126 can identify a first set of cards that were generated (e.g., dealt by the dealer 124 and/or scanned by the scanner 122) at a time of the request (e.g., t=1). Sometimes, the table computer 126 can identify a set of cards that were generated within some predetermined time range from the time of the request, t=1. If, for example, a set of cards was generated at the same time as t=1, then the table computer 126 can identify that set of cards in block E. As another example, if a first set of cards was generated at a time that is several seconds before time t=1 and a second set of cards was generated at a time that is several seconds after time t=1, then the table computer 126 can identify the first set of cards. As yet another example, the table computer 126 can identify a set of cards that were dealt and generated at the time of the request in block C, such as time t=1.

In block F, the table computer 126 can identify a first card in the set that maps to a roulette value. In other words, the table computer 126 can identify a first card in a card sequence of the identified first set of cards that is mapped, according to mapping data, to a roulette value. Any cards in the first set that are not mapped to roulette values can be discarded and therefore not used in the game of roulette. Refer to FIGS. 1A-B for further discussion.

The table computer 126 can also determine a game outcome based at least in part on the mapped roulette value in block G. The determination can also be made based on applying known roulette gaming rules to the mapped roulette value. In other words, the table computer 126 can determine whether the player A won the bet(s) they placed at time t=1 based on the roulette value that resulted in block F.

The table computer 126 can transmit the first card with the mapped roulette value and/or the game outcome to the device 104 in block H. Sometimes, the first card with the mapped roulette value can be transmitted at a first time and the game outcome can be transmitted at a second time. The first and second times can be the same. The first and second times can also be different. For example, the first time can be before the second time. A threshold amount of time may also pass between the first and second times. Other variations in timing of transmitting data to the device 104 are also possible.

Sometimes, whenever sets of cards are generated in block A, the table computer 126 can transmit those sets of cards to the device 104. The device 104, instead of the table computer 126, can then perform one or more of blocks E-G. This can be advantageous to reduce an amount of processing at the table computer 126. By offloading such processing to the device 104 and other player computer devices, the table computer 126 can more efficiently use its computational resources to make other determinations (e.g., determining gaming outcomes).

Still referring to FIG. 2C, the blocks described in reference to the game of player A can also be performed in reference to the game of player N. Here, player N starts the game at t=2 (block I). At t=2, the player A can be done with a first game of roulette and starting a new game of roulette. Sometimes, the player A may still be placing bets at time t=2. In such a scenario, the players A and N may receive the same roulette value that corresponds to a card that was dealt at or around t=2.

The device 106 of the player N can request a set of cards at t=3 in block J. t=3 can be any time after t=2 and/or any other times described above. t=3 can also be a same, earlier, and/or later time as any of the other times described above in reference to FIG. 2C. Sometimes, the request for a set of cards can be made at t=2, when the player N begins the game.

The table computer 126 can identify a second set of cards that was generated at the time of the request (block K). As described above, the table computer 126 can identify cards that were dealt at t=3, t=2, and/or any time within some predetermined range from t=3 or t=2. The table computer 126 can then identify a first card in the second set that maps to a roulette value (block L), as described in reference to block F. The table computer 126 determines a game outcome for player N based on at least the mapped roulette value in block M (refer to block G for further discussion). Then, the table computer 126 can transmit the first card with the mapped roulette value and/or the game outcome to the player N's device 106 in block N (refer to block H for further discussion).

In some implementations, the roulette gaming rules can be locally stored at the device 106 and used by the device 106 to determine the game outcomes. As a result, compute resources of the table computer 126 can be more efficiently allocated for other determinations and/or processes described herein. Sometimes, the game outcome(s) can be determined and then transmitted for each stage of gameplay in blocks H and N. Sometimes, the game outcome(s) can be determined and transmitted at the end of the game in blocks H and N.

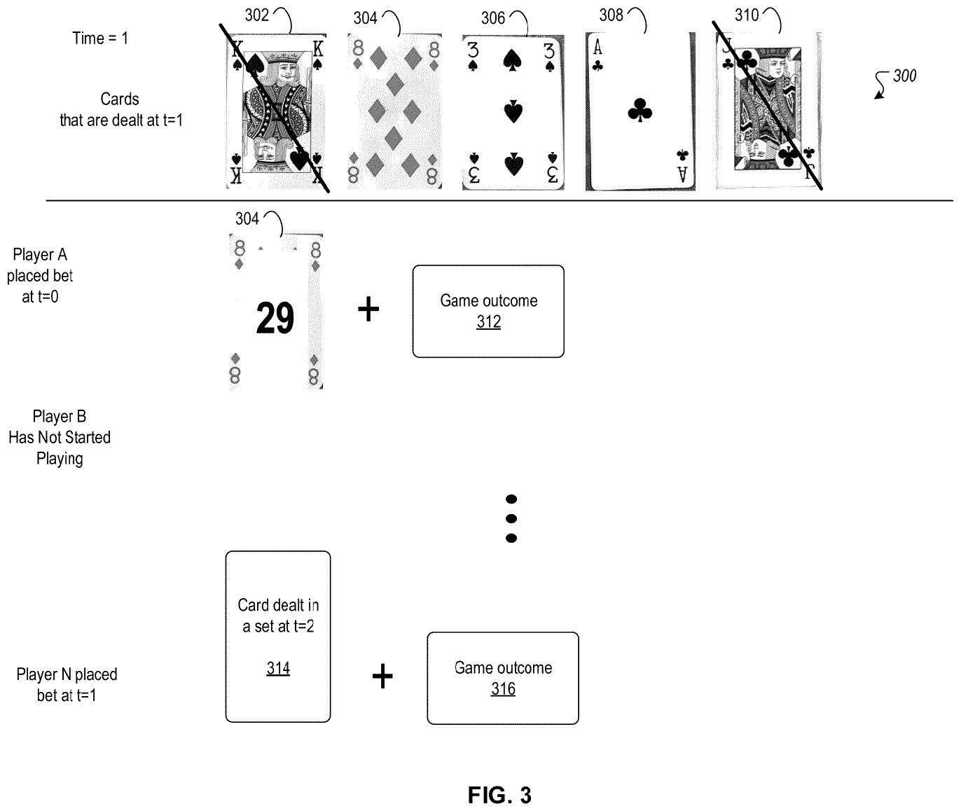

FIG. 3 depicts example game play using cards that are continuously dealt with an example card-based electronic roulette gaming system. At time t=1, physical cards hand 300 are dealt by a dealer, as presented above the line. Cards that are presented to example players A-N on computing equipment, such as devices 104-118 and 136-138, are presented below the line.

The hand 300 includes cards 302, 304, 306, 308, and 310. As shown, player A placed a bet at time t=0. As a result, the player A receives the card 304 with its corresponding roulette value (refer to FIG. 1B for further discussion about identifying cards that are mapped to roulette values). After all, the card 304 is the first card in a card sequence of the hand 300 that is mapped to a roulette value. The card 302, which appears first in the card sequence is a face card, which, according to the example mapping data described herein, is considered a non-value card. The player A can also receive a game outcome 312, presented at their respective computing device, based on the roulette value associated with the card 304 and any bets that were placed by the player A at t=0.

Player B has not yet started a game (e.g., did not place bets). Therefore, they do not receive any card or associated roulette value at time t=1.

Player N placed one or more bets at time t=1. In this example, player N receives a card 314 that was dealt in a set at time t=2. The player N also receives a game outcome 316, which is based on the roulette value associated with the card 314 and any bets that were placed by the player N at t=1. In some implementations, the computer system described herein can identify the card 304 from the first hand 300 that was dealt at time t=1 if the player N's bets are placed within a threshold amount of time of time t=1. In such a scenario, the player N can receive the card 304 and the game outcome 316 can be based on the roulette value associated with the card 304 and the bets placed by the player N at time t=1.

The computer system can utilize one or more known roulette gaming rules to determine the gaming outcomes and payouts to the players A, B, and N. A variety of factors can additionally impact gaming outcome determinations for each of the players A, B, and N as well as payout odds, such as the type of game that a player selects to play, the bet amount relative to the minimum bet denomination (e.g., max bet amount for a game can have greater odds than the minimum bet amount), the location at which the game is being played (e.g., game in bar can use payout table with different odds than standalone gaming equipment/table on floor of race track), the type of equipment on which the game is being played (e.g., standalone gaming equipment/table can have greater odds than gaming provided on mobile computing equipment), whether the game is part of a progressive jackpot pool (e.g., electronic touchscreens part of a progressive pool that builds over time until a player gets a particular type of hand(s) can have different odds than electronic touchscreens that are not part of a progressive pool), and/or other factors.

In some implementations, the computer system can apply one or more other rules or algorithms to determine which cards in the card sequence of the hand 300 and other subsequent hands should be identified for purposes of providing a roulette value to the players A, B, and N.

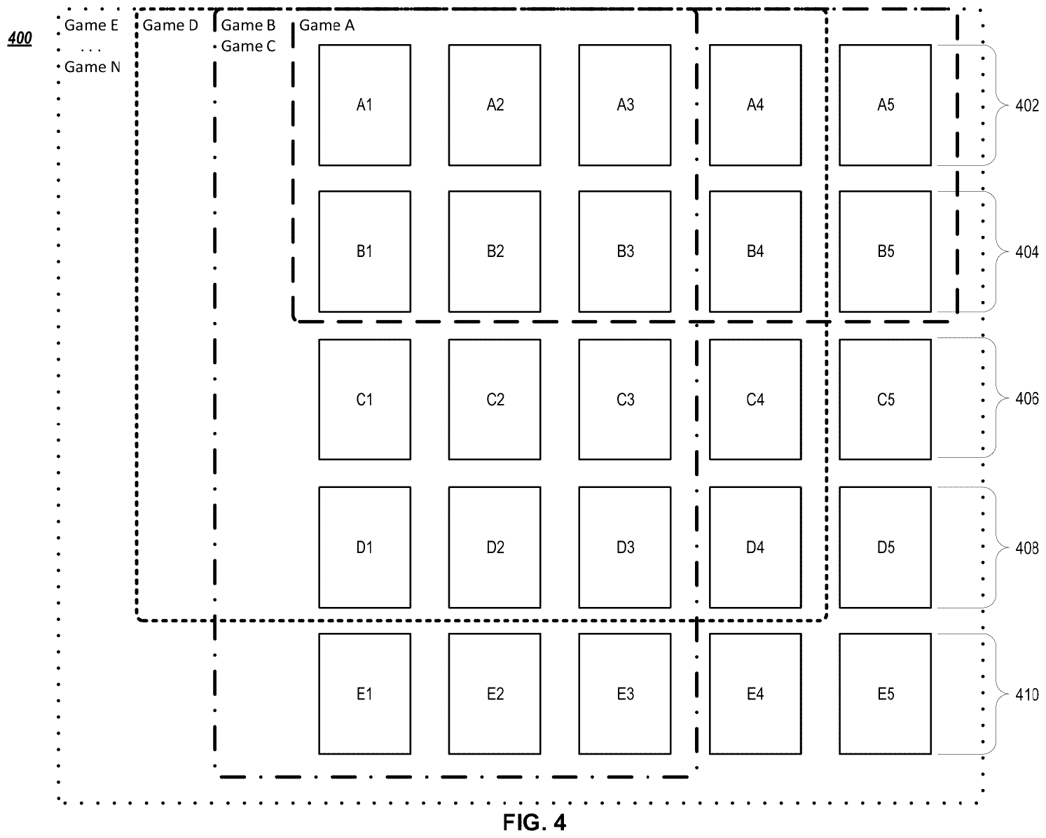

FIG. 4 depicts an example grid 400 of continuously dealt playing cards, which may be used with games such as roulette described herein. Depicted in FIG. 4 are various example predefined areas, Games A-N, of the grid 400. Physical cards are dealt by a dealer (e.g., dealer 124) into the grid 400, which are then used by an electronic table computing device, such as table computer 126. In some implementations, the grid 400 is constructed based on a sequence of previously dealt and recorded cards. Each of the predefined areas of the grid 400 may be used by the table computer 126 for a particular type of game, Game A, Game B, and so forth, for which the table computer 126 provides gaming outcomes. Moreover, the cards in the grid 400 can be continuously shuffled and/or dealt, as described herein. Sometimes, all of the cards in the grid 400 can be shuffled (all 25 cards). Sets of cards can then be determined along different rows, horizontals, cross-crosses, etc. of the grid 400. This can allow for multiple games to be played in a same screen or interface (e.g., each row can represent a different game that can be played at a same time). Once the cards are shuffled, sets of the shuffled cards can then be transmitted to player devices of the players as described in above. Sometimes, fewer than all 5 sets depicted in the grid 400 can be continuously shuffled and used to generate new sets of cards.

As depicted in FIG. 4, grid 400 includes cards A1-5 in row 402, B1-5 in row 404, C1-5 in row 406, D1-5 in row 408, and E1-5 in row 410. Grid 400 is depicted as including five rows, rows 402-410, and five columns; however, any combination of rows and columns may be employed by the system to determine gaming outcomes.

In the depicted example, the table computer 126 uses cards A1-5 and B1-5 for Game A. The table computer 126 can select cards for gameplay based on card position in the grid 400. The cards A1-5 and B1-5 can also be continuously shuffled for the Game A. A player may be assigned a starting position in the grid 400 or section of the grid assigned to the particular game from which the table computer 126 may select cards. The table computer 126 may select cards sequentially or based on a step sequence (e.g., every other card) from the grid 400, starting from the starting position or based on a draw order assigned to the player or player's hand. For example, A1 may be the starting position and a step sequence of every other card being selected (e.g., A3 would be the second card selected, A5 would be the third cards selected, B2 would be the fourth card selected, and so forth). Other possible algorithms may be used to determine the initial hand and hit cards from the grid 400 for the particular game.

As an illustrative example in a game of five-card draw poker, the table computer 126 may replace A2 from a player's hand when discarded during a player's action with card B2, where card B2 was generated in the row 404 at a same or similar time as the player discarded card A2. Alternatively, the table computer 126 may provide a replacement card based on the sequential order of the row. For example, B1 would replace the first card discarded during a player action regardless of the position of the discarded card and so forth. In another alternative implementation, the table computer 126 can use a draw order for the draw cards that is assigned to each player. In a similar manner, the table computer 126 may use each predefined section of grid 400 (e.g., Games A-N) and a draw order, which may be updated between games and/or a series of games, for each predefined section to provide gaming outcomes to the player devices for each type of game supported by the table computer 126.

As an example, assuming that Game A is five-card draw poker, an outcome for each player is determined based on the final five cards in each player's hand, which, as indicated above, may be based on the Game A section of grid 400, different sets of cards that are continuously shuffled in any of the Game A-N sections of the grid 400, a draw order, each player's action, and/or timing of each player's action. In this example, a player with a pair may receive a 1:1 payout, a player with two pairs may receive a 3:2 payout, and a player with a royal flush may receive a 100:1 payout. Odds and outcomes can vary and can be determined using payout tables that correlate a hierarchy of poker hands to different payout odds. For example, the devices 104-118 and 136-138 can permit players to select a type of five-card draw poker game (e.g., Jacks or Better, Tens or Better, Deuces Wild, Bonus Poker, Double Bonus Poker) that they are playing, which can each have different payout tables that provide different odds for different types of hands. In addition to having different gaming outcomes based on the cards that players decide to discard from their initial hand, a variety of other factors can additionally determine the outcome for the player and the payout odds, such as the type of game that a player selects to play, the bet amount relative to the minimum bet denomination (e.g., max bet amount for a game can have greater odds than the minimum bet amount), the location at which the game is being played (e.g., game in bar can use payout table with different odds than standalone gaming device/table on floor of casino), the type of device on which the game is being played (e.g., standalone gaming device/table can have greater odds than gaming provided on mobile device), whether the game is part of a progressive jackpot pool (e.g., gaming devices part of a progressive pool that builds overtime until a player gets a particular type of hand(s) can have different odds than gaming devices that are not part of a progressive pool), and/or other factors.

For instance, under a Deuces Wild game, the player may not win the hand unless he/she attains a hand of three of a kind or better (with deuces being wildcards), whereas with the Jacks or Better game, the player may win the hand when he/she attains a pair of jacks or better—the payout table for these games correlates different hands within the hierarchy of poker hands to different outcomes and odds. The gaming outcome for players, and in particular the payout ratio, can depend on a bet amount and/or the location at which the game is being played (e.g., local at the table can have the highest payout, remote location within the gaming facility can have next highest payout, and remote connection outside the gaming facility can have lowest payout—other schemes are also possible). For example, many electronic games can permit a player to bet in increments of a minimum bet amount (e.g., $0.05/hand) up to a maximum bet (e.g., 5× maximum bet for maximum of $0.25/hand). However, the payout for some maximum bets (e.g., 5× bet) can be greater than the multiplier for the maximum bet. For instance, a royal flush may payout at 300:1 for a 1× bet of the minimum bet amount, whereas a royal flush may payout at 3000:1 for a 5× bet of the minimum bet amount, which is a 10× multiplier of the payout for a 5× multiplier of the bet amount.

The devices 104-118 and 136-138, the table computer 126, and/or the computer system 128 can be programmed to provide electronic gaming outcomes to the players based on the cards in grid 400 that are continuously shuffled/dealt; the predefined section of the grid 400 mapped to the current game (e.g., Games A-N), a selection algorithm that determines the initial poker hands and draw cards based on, for example, a draw order; the player discard actions; the poker game selected by each player; and the bet amounts placed by each player. For instance, referring to the example grid 400 depicted in FIG. 4, the selection algorithm for a poker game may designate one of the rows of cards (e.g., row 402 with cards A1-A5) as the initial hand that provided to each player, and from which players can individually select discards. Once players have entered their discard actions, the remaining rows of cards can be dealt (e.g., deal rows 402-410) based on times at which each of the players enter their discard actions. For example, players who discard cards at time t=1 can receive cards from the row 404 as replacement cards, players who discard cards at time t=2 can receive cards from the row 406, players who discard cards at time t=3 can receive cards from the row 408, and players who discard cards at time t=4 can receive cards from the row 410. One or more other arrangements for providing cards to the players are possible.

The selection algorithm can use any of a variety of techniques to allocate draw cards from the remaining rows for each of the players, which provide for variation in which draw cards are allocated to each of the players. For example, the selection algorithm can assign different draw orders across some or all of the cards in the remaining rows to the players, such as assigning different orderings of cards within the same row (e.g., each player assigned different order of cards B1-B5 for row 404), assigning different rows of cards to each player (e.g., each player assigned one of rows 404-410), assigning different orderings of cards across different rows (e.g., each player assigned different order of cards B1-E5 for rows 404-410), and/or combinations thereof. The assignments can be automatically determined by the system and/or based on user input/selection. For instance, if the row 402 (cards A1-A5) is used to provide the initial hand, each player may be given the option to select one of the rows 404-410 (example of four remaining rows is depicted, but other numbers of rows from which players can select may be provided—such as two rows, three rows, five rows, etc.) to provide the draw order for the player. The selected row 404-410 for each player may then be (1) continuously shuffled, (2) continuously dealt, and/or (3) used to replace discards for each player using any of a variety of appropriate techniques, such as starting with a first card in the selected row and proceeding sequentially through the row (e.g., replace first discard with B1, next discard with B2, and so on), replacing each discard with a corresponding positioned card within the selected discard row (e.g., replace discard A2 with corresponding card B2 in selected row 404, replace discard A5 with corresponding card A5 in selected row 404), and/or combinations thereof. Other techniques and processes for selecting cards to replace discards are also possible.

The devices 104-118 and 136-138 can be part of a pool of gaming devices that provide progressive jackpots, which are jackpots that build over time until a player gets a particular hand (e.g., royal flush, straight flush). For example, the devices 104-118 can be part of the same progressive pool that builds over time until a player at one of those devices 104-118 gets a particular hand that wins the progressive jackpot, such as obtaining a royal flush. There can be multiple different progressive pools across different groups of gaming devices.

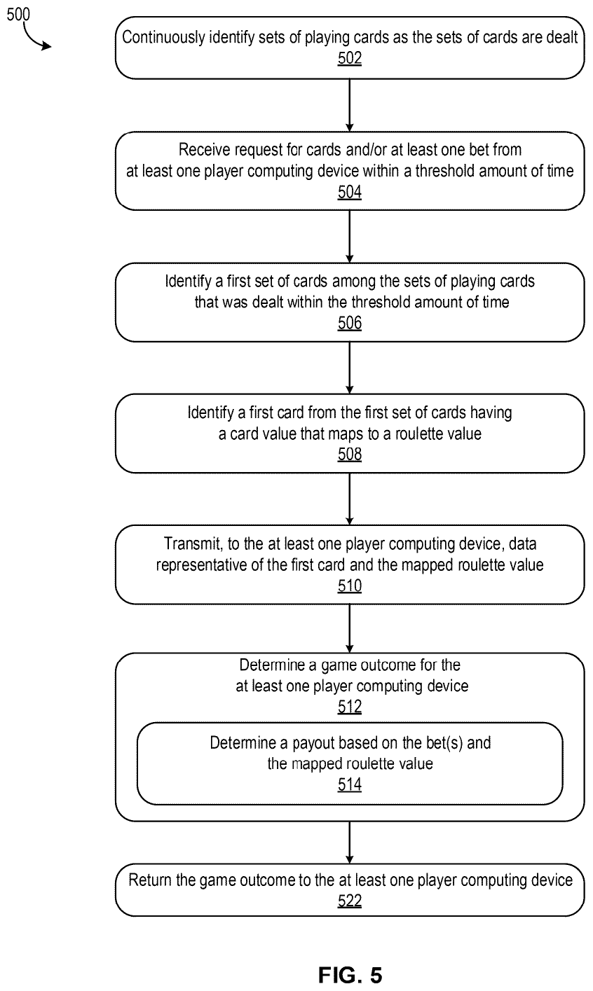

FIG. 5 is a flowchart of an example technique 500 for performing card-based electronic roulette gaming. The example technique 500 can be performed by any of a variety of appropriate computing equipment and/or systems, such as the table computer 126, the player computing devices 104-118 and 136-138, and the computer system 128. For illustrative purposes, the technique 500 is described from the perspective of a computer system.

Referring to the technique 500, the computer system continuously identifies sets of playing cards as the sets of cards are dealt (block 502). For example, based on a plurality of sets of playing cards with one set of playing cards being dealt successive to another set of playing cards, the computer system can continuously identify the plurality of sets of playing cards. Physical cards that are going to be continuously shuffled and dealt across the players and their equipment as additional gameplay actions are taken, determined, and/or identified. As described above, the dealer can continuously shuffle cards for a duration of gameplay. The cards can be shuffled into sets, which are scanned so that the computer system can identify subsets of a set of card to be provided to the player devices 104-118 and 136-138 when the player requests to play a game of roulette or otherwise places one or more bets. The table computer 126 can detect five cards (e.g., cards C1-C5) that are physically dealt by a dealer from the shoe 120 at a first time using the scanner 122. The scanner 122 can therefore identify each of the physical cards as they are dealt by the dealer at a gaming table.

In block 504, the computer system can receive a request for cards and/or at least one bet, and/or side bet from at least one player computing device. Sometimes, the computer system can determine whether each player is currently in play. The at least one player computing device can output, in a graphical user interface (GUI) display, a graphical representation of a roulette table. The player computing device can then receive user input selecting a portion of the graphical representation of the roulette table. That user input can indicate a bet. The bet can include at least one of a player-selected roulette value, a player-selected pair of roulette values, a player-selected row of roulette values on a graphical representation of a roulette table, a player-selected column of roulette values on the graphical representation of the roulette table, player-selection of each corner of the graphical representation of the roulette table, player-selection of red roulette values on the graphical representation of the roulette table, player-selection of black roulette values on the graphical representation of the roulette table, player-selection of first, second, or third roulette values on the graphical representation of the roulette table, player-selection of a lower half of roulette values on the graphical representation of the roulette table, or player-selection of an upper half of roulette values on the graphical representation of the roulette table.

Still referring to block 504, the table computer 126 can receive input from the devices 104-118 and 136-138 of the players indicating that the player has joined the game, enrolled, and/or gaming balances have been removed from the players. The table computer 126 can also receive input from the devices 104-118 and 136-138 indicating a request for a roulette value. The table computer 126 can also determine whether each player is in play based on how much time has passed since the player last provided input or took some action in the game. If, for example, the player's last action was taken during a window of time that exceeds some threshold range (e.g., 10 minutes), then the table computer 126 can determine that the player is not currently in play. The player may, for example, have stepped away from their device 104-118 and 316-138 to do some other activity (e.g., get food, go to the restroom, or altogether stop playing the game).

If the table computer 126 determines that none of the players are in play, then the table computer 126 can merely continue to detect shuffled/dealt sets of cards. If at least one player is in play, then the table computer 126 can determine whether the player is starting a game and a roulette value, thereby performing block 506. This determination can be made based on information that is received from the devices 104-118 and 136-138. For example, each of the devices 104-118 and 136-138 can determine a stage of gameplay of each player. The devices 104-118 and 136-138 can transmit the determined stage of gameplay to the table computer 126, which the table computer 126 can use to determine whether the player is requesting initial hands. As a result, computational resources can be more efficiently used at the table computer 126 by offloading the stage determination processing to the individual player computing devices 104-118 and 136-138. In other implementations, the table computer 126, the computer system 128, or other suitable computer(s) can determine the stage of gameplay of each player.

The computer system identifies a first set of cards among the sets of playing cards in block 506. For example, based on the request from at least one of the plurality of player computing devices, the computer system can identify the first set of playing cards among the plurality of sets of playing cards being continuously identified. As described herein, the computer system can identify the first set of playing cards having a same timestamp or a timestamp within some threshold amount of time of a timestamp associated with the request.

The computer system identifies a first card from the first set of cards in block 508. More particularly, the computer system can identify a first card from the first set that has a card value that maps to a roulette value. The computer system can determine the roulette value for the first card using mapping data, the mapping data indicating a mapping of card values to roulette values. If a card in the first set of cards does not have a mapping or association to a roulette value, according to the mapping data, then the card can be discarded from the first set. As described above, the computer system can identify a first card in a card sequence of the first set of cards that is mapped to a roulette value. Even if a second card in the card sequence is also mapped to a roulette value, the computer system may identify the first card in the card sequence in block 508. Refer to FIGS. 1A-B for further discussion.

In some implementations, in response to determining that none of the cards in the first set of cards have a card value that is mapped to a roulette value in the mapping data, the computer system can identify a second set of cards among the sets of playing cards being continuously identified, identify, among the second set, a first card, determine a roulette value for the first card in the second set based on the mapping data, transmitting, to the at least one player computing device, data representative of the first card in the second set and the roulette value for the first card in the second set, and determine the outcome of the game of roulette for the based at least in part on the roulette value for the first card in the second set. The first set of cards is different than the second set of cards. The computer system can continue analyzing subsequent sets of continuously dealt cards until the player's bets are reconciled (e.g., a card is identified in a set that is mapped to a roulette value).

In block 510, the computer system transmits, to the at least one player computing device, data representative of the first card and the mapped roulette value for the first card. The at least one player computing device can output, in response to receiving the data, a graphical representation of the first card with the mapped roulette value in a GUI display at the player computing device. More particularly, the at least one player computing device can output, in the GUI display, the graphical representation of the first card with the roulette value overlaying a portion of the graphical representation of the first card. The roulette value can be displayed in a center portion of the graphical representation of the first card and an actual value of the first card can be displayed in first and second corners of the graphical representation of the first card.

The computer system determines a game outcome for the at least one player computing device in block 512. For example, the computer system can determine a payout based on the bet(s) placed by the player at the at least one player computing device and the mapped roulette value (block 514). Then, the computer system can return the game outcome to the at least one player computing device in block 522.

Players that start the game at or around the same time can each receive and be presented with the card and corresponding roulette value. The players can also place bets or make other individual game decisions at different times, and therefore receive different cards and their corresponding roulette values, even if the players initially started the game together. Accordingly, the players can continue to play the game at their desired paces. Players can employ different gameplay strategies, which may also cause their timing/pacing to be different, and thus to experience different game outcomes and/or receive different roulette values.

In some implementations of the technique 500, additional processes can be performed. For example, the player computing devices/equipment that are going to play a game of roulette can be enrolled and debits for playing the game can be taken against gaming balances for each player. For example, the devices 104-118 and 136-138 can enroll with the table computer 126 and/or the computer system 128 to play in a next game of roulette on the table 102, and a debit/ante to play the game can be taken from each player's virtual gaming balance that is maintained on devices 104-118 and 136-138, the table computer 126, and/or the computer system 128. The players can be enrolled at different times, based on whenever each of the new players desire to join or start the game.

Enrolling a new player can include, for example, the player either creating or providing player account information via the devices 104-118 and 136-138. For example, a new player may create a new player account by physically and/or electronically depositing money via the devices 104-118 and 136-138, the table computer 126, and/or the computer system 128 (e.g., feeding physical money into a bill reader that is part of/connected to the devices 104-118, providing credit/debit card information, providing bank account information). A unique account identifier can be created and funds deposited into the account can be credited to the account by the table computer 126 and/or the computer system 128, for example, as part of a ticket-in ticket-out (TITO) system. Players with preexisting accounts can provide account information via the devices 104-118 and 136-138 through one or more input mechanisms, such as through a physical ticket reader (e.g., ticket reader to read unique account identifier encoded on the ticket), through a player card reader (e.g., magnetic strip reader, RFID reader), through input of a username and password, and/or through other input mechanisms. New players can be prompted through one or more selectable options to designate a type of poker game they want to play and/or to designate a bet amount for the next roulette game.

Enrolling existing players can include receiving input from the players at any point during the game. The time at which the player provides input to start a game can be used to determine which roulette value the player receives, as described above. Therefore, the game can have continuous progression and players that are currently playing or wanting to start the game do not need to wait for other players to make a decision or otherwise opt in to join the game.

In some implementations, however, enrolling existing players in a next roulette game can include players either providing or not providing particular types of input within a threshold amount of time for the next game to start. For example, in some instances players may opt-in to play a next game, and can be provided with a time-limited selectable option to opt-in to game play for a next roulette game at a table where the player just finished a game. Failure to select the option within a threshold amount of time can cause the player to sit-out the next game. In other instances, the player may have to opt-out to avoid repeating his/her bet in a next stage of gameplay of a current game of roulette, and can be provided with a time-limited selectable option to opt-out of gameplay. Failure to select the option within the threshold amount of time can cause the player to be automatically enrolled in the next stage of gameplay at the same bet amount. Other opt-in and opt-out options are also possible, such as a player designating a bet amount for a next roulette stage of gameplay or new game entirely as an implicit opt-in for a game. Existing players can additionally be provided with selectable options between stages of gameplay to change the type of game that they are playing between and/or to change their bet amount.

In another example, players can similarly switch between tables upon completing a game (switch to a new table after the end of one iteration of the technique 500 and before starting another iteration of the technique 500). For example, a player can designate that he/she is ready to start another game and can select an option to be switched to another table that is starting a new game, in response to which the player electronic touchscreen can be switched to gaming with cards dealt on another table. Other options for switching between tables are also possible, such as providing input (e.g., designating a bet for the new game), the user designating that he/she is ready to play a new game, the user designating that he/she wants to be moved to another table, and/or other options.

The system 100 and, particularly, the shoe 120 can be specifically adapted to provide for efficient and repeated gaming, for example, using the technique 500. For example, the shoe 120 can be a six-deck continuous shuffle shoe such that multiple decks of cards can be shuffled together and dealt from the shoe 120. In alternative examples, the shoe 120 can include multiple decks other than six. The systems according to implementation of the present disclosure provide gaming that are amenable to using multiple decks of cards that are all shuffled together and dealt from the shoe 120, as with other types of card-based gaming, like blackjack. For example, the six-deck continuous shuffle shoe 120 in the system described herein can provide for more efficient repeated game play (e.g., no need to shuffle between each game), without significantly reducing player odds, which may be more appealing to players than with conventional roulette equipment. To maintain the same odds that are provided with conventional electronic roulette equipment while using physical cards in a configuration that allows for efficient and repeated game play, the shoe 120 and shuffling systems (e.g., automatic shuffling machines, human shufflers) can be adapted in a couple different ways. As mentioned above, the shoe 120 can be a six-deck continuous shuffle shoe. In another example, automatic shuffling machines can be adapted to receive multiple decks of cards, with each deck of cards being separated by a physical delimiter (e.g., plastic card separator, change in card orientation). The automatic shuffling machines can then shuffle each deck separately and output a stack of randomly shuffled decks, where each deck is separated by a physical delimiter. When dealing the cards from the shoe 120, the dealer 124 can deal a preset number of cards from the first deck in the shoe 120 for the first game and then discard the remainder of the cards from the first deck (at the conclusion of the first game), then deal a preset number of cards from the second deck in the shoe 120 and then discard the remainder of the cards from the second deck, and so on until all of the decks have been dealt. By doing this, the dealer 124 can deal multiple games without having to shuffle or obtain shuffled cards for each game, which can increase the pace of gameplay, and without having to resort to using multiple decks of cards, which could lower player odds for the game.

In another example, automatic shufflers can be adapted to output a present number of cards from each deck for placement in the shoe 120 (instead of the entirety of each deck) and then the dealer 124 can simply and continuously deal games using the technique 500. By doing this, the gameplay can be made even more efficient by not requiring the dealer 124 to remove the remainder of the deck before starting a next game. This can present potential problems with keeping decks of cards separate from each other, which can be accomplished by marking cards with a unique identifier for the deck to which the card belongs (in addition to each card in a deck being marked with an identifier for the card (suit, card number)). An automatic shuffler can be programmed to receive a group of cards from mixed decks, to separate the cards into their respective decks based on the deck identifiers, and then to shuffle each deck separately from the other decks. If a deck is found to be incomplete after receiving all available cards, the cards from that deck can be discarded as being part of an incomplete deck. By doing this, the dealer 124 can more efficiently deal multiple games without having to shuffle or obtain shuffled cards for each game, which can increase the pace of gameplay, and without having to resort to using multiple decks of cards, which could lower player odds for the game.

Automatic shufflers and the system 100 can additionally and/or alternatively be adapted to continuously shuffle and use decks with greater than 52 cards, such as decks that include one or more jokers. Each table can include one or more automatic shufflers, such as tables having two, three, or more automatic shufflers to concurrently shuffle multiple decks of cards. Shufflers can be configured to output cards in groups, such as outputting sets of five cards together that can be used as the initial hands and the hit cards. The automatic shufflers can accommodate one or more decks at a time.

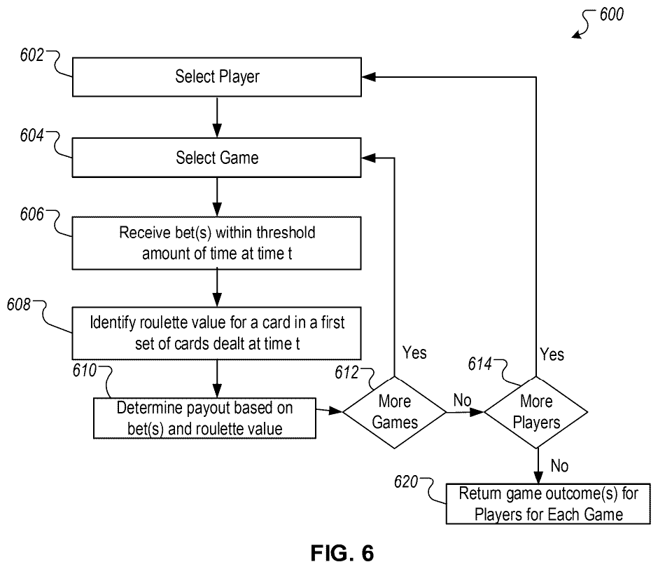

FIG. 6 is a flowchart of another example technique 600 for determining gaming outcomes for multiple games that are simultaneously played as cards are being continuously dealt. The example technique 600 can be performed by any of a variety of appropriate computing devices and/or systems, such as the table computer 126, the computing devices 104-118 and 136-138, and the computer system 128. The technique 600 can be performed, for example, as part of the technique 500 (e.g., refer to FIG. 5).

For some games, cards can be selected from a grid based on the cards each having a position that is established based on an order in which the cards were dealt. In the example of the grid 400 in FIG. 4, cards A1 and A3 can be used to build the initial first hand and cards A2 and A4 can be used to build the initial second hand for a game of baccarat. When hit cards are required, they can be drawn from another grid, such as from cards B1-5 that are dealt after cards A1-5. The starting position in the grid for reading the hit cards can be a first sequential card that is drawn or dealt in that grid. For example, in the grid 400 in FIG. 4, card B1 can be a first hit card drawn for either the initial first or second hands. Card B2 can be a second hit card drawn for initial hand that did not receive the card B1, assuming according to baccarat gaming rules, the initial hand that did not receive the card B1 should also receive a hit card.

For other types of games that require draw cards (e.g., draw poker), the cards selected for a player can be viewed as each having a position that is established based on the order in which the draw cards were selected (e.g., the cards order in the grid) or based on an order assigned to the cards for the player. When draw cards are read from the same grid or grid section, the starting position in the grid for reading the draw card can be the next sequential card after the last card selected. When the draw cards are read from another grid than the cards read, the starting position in the other grid for reading the draw card can be the first card in the other grid or section of the other grid allocated to the particular game for which the cards are being selected. Draw cards can be selected by sequentially progressing through the remaining cards in the grid or grid section to fill the open spots in each player's hand resulting from player discards from their initial hand. For example, referring to grid 400 in FIG. 4, if cards A1-5 were used as players' initial hands in a game of poker, the next sequential positon would be B1. A first player who discarded two cards at a first time, will receive the next two sequential cards in the grid, B1 and B2. A second player who discarded three cards at the same time will receive the cards B1, B2, and B3. On the other hand, if the second player discarded three cards at a different time, then the second player can receive cards that were dealt in the grid at the different time. For example, the cards C1, C2, and C3 can be dealt at the same time or around the same time that the second player discarded three cards. Thus, the second player can receive the cards C1, C2, and C3 instead of the cards B1, B2, and B3, which were dealt at a different time.

As part of the technique 600, a player who is playing (either physically or virtually) at a table is selected (block 602). A game played by the selected player is selected (block 604), such as roulette (although other games can also be selected as described above), followed by receiving (block 606) at least one bet within a threshold amount of time at time t. A roulette value for a card in a first set of cards dealt at time t is identified (block 608), and a payout for the selected player is determined based on the bet(s) and the roulette value (block 610). Refer to the technique 500 in FIG. 5 for further discussion about performing blocks 606-610.

The blocks 606-610 can be repeated until the current game naturally ends or the player's bets are reconciled.

Once the current game ends, in block 612, a check is done as to whether the selected player is playing more than one game. If there are more games for that player, then blocks 604-610 are repeated for each game. If the player is not playing more games, then block 614 is performed.

In block 614, a check is performed as to whether there are more players physically and/or virtually playing at the table still playing the game of roulette. If there are more players, blocks 602-612 are repeated for each remaining player. Once the blocks 602-612 are performed, gaming outcomes for the players for each game can be returned in block 620, if they have not already been returned to the players.

Sometimes, any one or more blocks in the technique 600 can be performed simultaneously. For example, one or more of the blocks 604-614 can be simultaneously performed for each player playing one or more games at a same or similar time. Sometimes, one or more other rows in the grid 400 can be used to provide gaming outcomes to the players that are at different stages of gameplay at one or more different times. Thus, the entire grid 400 may be used for a game of roulette. In such an implementation, as described herein, the cards in row A1-5 may be used to identify a roulette value for a first player and cards in any of the other rows in the grid 400 can be used to identify a roulette value for a second, third, fourth, etc., player in the game of roulette.

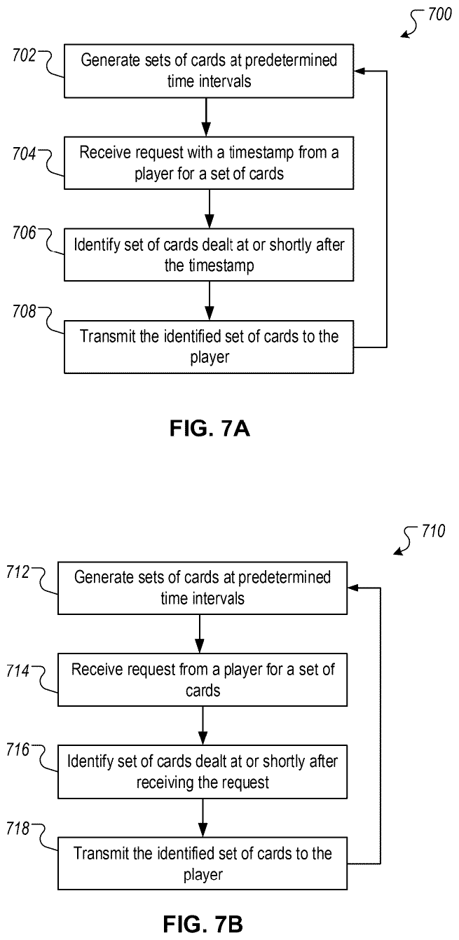

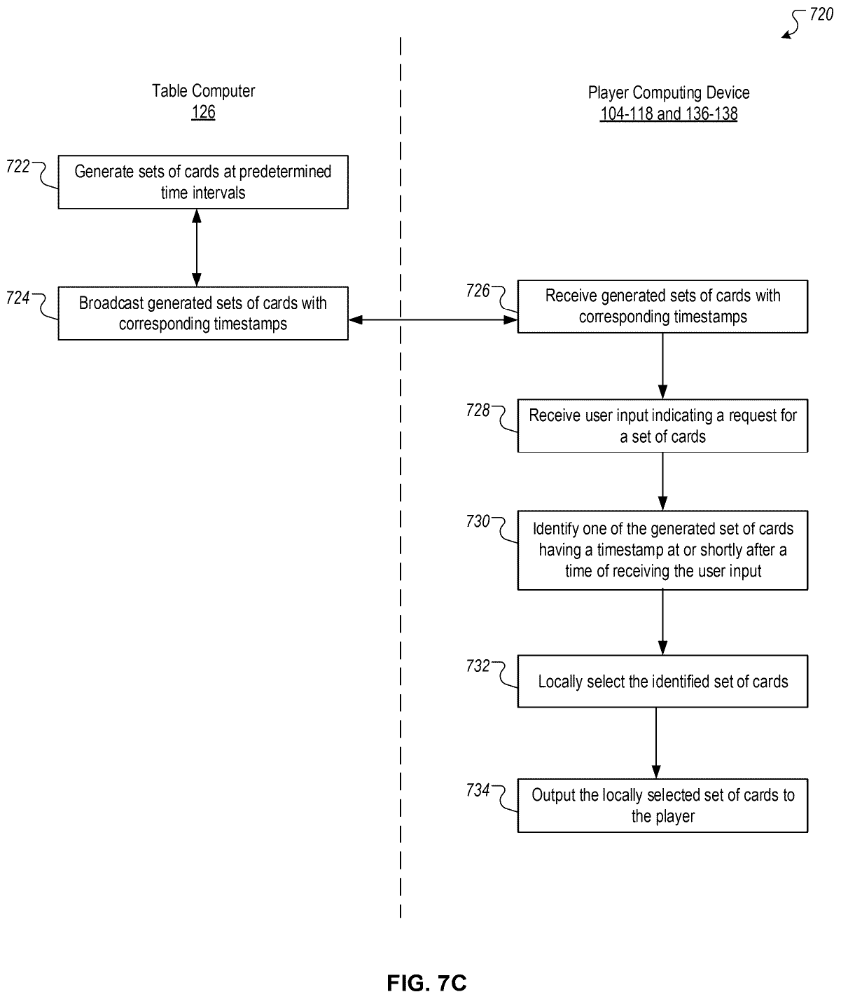

FIGS. 7A-C are flowcharts of example techniques 700, 710, and 720 for transmitting sets of cards to player computing devices. The techniques 700, 710, and 720 can be used to maximize output in terms of numbers of cards being played in a period of time. The example techniques 700, 710, and 720 can be performed by any of a variety of appropriate computing devices and/or systems, such as the table computer 126, the computing devices 104-118 and 136-138, and the computer system 128. The techniques 700, 710, and 720 can be performed, for example, as part of the techniques 500 and/or 600 (e.g., refer to FIGS. 5-6).

Referring to the technique 700 in FIG. 7A, sets of cards can be generated at predetermined time intervals (block 702). As described above in reference to FIGS. 1-3, the dealer (such as the dealer 124) can continuously deal sets of cards at the dealer's desired pace (e.g., as quickly as the dealer can deal and scan sets of cards). Each set of cards that is generated can include a timestamp indicating a time at which the set is generated and/or scanned by the scanner 122. Sometimes, the timestamp can be a relative timing that takes into consideration a time when the cards are physically dealt and a time at which the cards are scanned and registered by the table computer 126. Sets of cards can be continuously generated and scanned throughout the technique 700.

The table computer 126 can receive a request from a player device for a set of cards (e.g., initial first and second hands in baccarat, one or more hit cards) (block 704). The request can include a timestamp. The timestamp can indicate a time at which the player performed some action in the game, such as selecting an option to begin a new game, placing a bet on either initial first and second hands, or requesting one or more hit cards. The timestamp can also indicate a time at which the request for the set of cards is transmitted and/or received by the table computer 126.

The table computer 126 can then identify a set of cards that were dealt (block 702) at or shortly after the timestamp in the request (block 706). For example, the table computer 126 can determine which set of cards has been dealt within a predetermined threshold time range from the timestamp in the request. The table computer 126 can compare a timestamp of each set of dealt cards with the timestamp in the request. A set of cards having the same timestamp can be selected (block 706). In some implementations, a set of cards having a timestamp within a threshold amount of time after the timestamp in the request can be identified. In other implementations, a set of cards having a timestamp within a threshold amount of time before the timestamp in the request can be identified. In yet some implementations, if the timestamp in the request falls within the timestamps of a first set of cards and a second set of cards, the second set of cards can be selected to enhance game security (e.g., to ensure that no player has an upper hand or advantage on other players in the game). If game security would be unaffected by selection of a set of cards, then the first set of cards can be selected in order to increase pace of gameplay.

Moreover, in some implementations, selection of a set of cards can be based on decisions made based on timing of decisions that are made by a player, rather than the timestamp in the request. For example, if the player makes a decision prior to a fifth card in a current set of cards being drawn, then the player would receive at least one card from that current set of five cards. If the player makes a decision after the timestamp of the fifth card in the current set of cards that are being drawn, then the player would receive at least one card from a next set of five cards that are drawn by the dealer. After the set of cards are selected in block 706, the table computer 126 can transmit the identified set of cards to the player (block 708).

Referring to the technique 710 in FIG. 7B, sets of cards can be generated at predetermined time intervals (block 712). Refer to block 702 in the technique 700 depicted in FIG. 7A. The table computer 126 can receive a request from a player device for a set of cards (block 714). The request may not include a timestamp. Accordingly, unlike the technique 700, the table computer 126 can identify a set of cards that were dealt at or shortly after receiving the request (block 716). The table computer 126 can then transmit the identified set of cards (or a subset of the identified set of cards) to the player's device (block 718).

Referring to the technique 720 in FIG. 7C, sets of cards can be generated at predetermined time intervals (block 722). As described in reference to FIG. 7A, the dealer can continuously deal sets of cards, which can be scanned by the scanner and detected or otherwise registered by the table computer 126. The table computer 126 can then broadcast the sets of cards with corresponding timestamps (block 724). The table computer 126 can broadcast each set of cards as they are generated. Other times, the table computer 126 can broadcast sets of cards in batches (e.g., broadcast 2 sets of cards at a time, where each set has a different timestamp indicating when they were generated). The sets can be broadcasted to all player computing devices 104-118 and 136-138, regardless of whether players are actually playing the games at such devices. Sometimes, the sets can be broadcasted only to those devices 104-118 and 136-138 where players are currently playing the game. For example, the table computer 126 can receive notifications from the devices 104-118 an 136-138 that indicate that a player has started a game or taken some action in a game. The table computer 126 can then broadcast the sets of cards to only those devices.

The player computing devices 104-118 and 136-138 can receive the generated sets of cards with their corresponding timestamps (block 726). The devices 104-118 and 136-138 can also receive user input indicating a request for a set of cards (block 728). The user input can be some action that is taken in the game by the player. For example, the player can select an option to start a game, which can be user input indicating that player user needs initial first and second hands of cards. The player can also place one or more bets on current initial first and second hands, which can be user input indicating that gaming outcomes may be determined and/or hit cards may be identified and assigned.

Sometimes, the user input can be received before one or more of the generated sets of cards are received. Sometimes, the user input can be received at a same time as one or more of the generated sets of cards. Moreover, as described above, the devices 104-118 and 136-138 can continuously receive the generated sets of cards, regardless of when the devices 104-118 and 136-138 receive user input indicating a request for a set of cards.

The devices 104-118 and 136-138 can identify one of the generated sets of cards having a timestamp that is at or shortly after a time that the devices received the user input (block 730). For example, the devices 104-118 and 136-138 can temporarily store the sets of cards that are broadcasted by the table computer 126 in 724 and received in 726. The devices 104-118 can look at the timestamps for each of the sets of cards in temporary storage and determine which timestamp falls within some predetermined threshold range of time from the time of the request for a set of cards. A set of cards that were dealt at a same time as the request can be identified. A set of cards that were dealt within a threshold amount of time after the request was received can be identified. In some implementations, a set of cards that were dealt within a threshold amount of time before the request was received can be identified.

The devices 104-118 and 136-138 can then locally select the identified set of cards (block 732). Performing blocks 730-732 at each of the devices 104-118 and 136-138 can be advantageous to more efficiently utilize computational resources, especially at the table computer 126. The table computer 126 can then operate more efficiently and quickly since it does not have to determine, for each player, which set of cards each device 104-118 and 136-138 should receive.

Finally, the devices 104-118 and 136-138 can output the locally selected set of cards (or a subset of the locally selected set of cards) to the player (block 734). The player can then take some action in the game based on their updated hand, and the blocks 722-734 can be repeated until the game ends/one of the first and second hands wins.

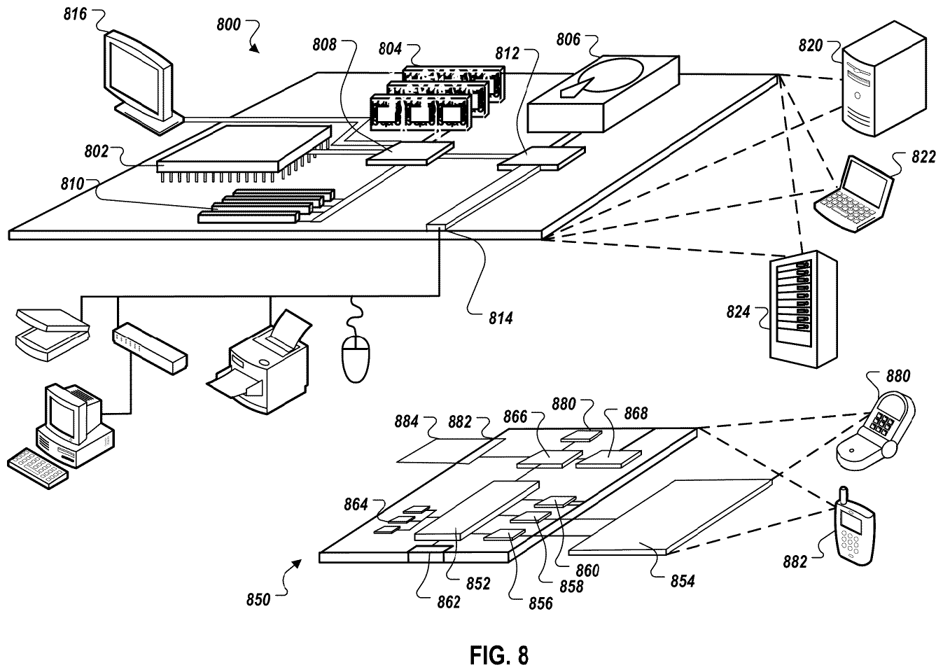

FIG. 8 shows an example of a computing device 800 and an example of a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and can be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 can also be another form of computer-readable medium, such as a magnetic or optical disk.

The storage device 806 is capable of providing mass storage for the computing device 800. In some implementations, the storage device 806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which can accept various expansion cards (not shown). In the implementation, the low-speed interface 812 is coupled to the storage device 806 and the low-speed expansion port 814. The low-speed expansion port 814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 820, or multiple times in a group of such servers. In addition, it can be implemented in a personal computer such as a laptop computer 822. It can also be implemented as part of a rack server system 824. Alternatively, components from the computing device 800 can be combined with other components in a mobile device (not shown), such as a mobile computing device 850. Each of such devices can contain one or more of the computing device 800 and the mobile computing device 850, and an entire system can be made up of multiple computing devices communicating with each other.

The mobile computing device 850 includes a processor 852, a memory 864, an input/output device such as a display 854, a communication interface 866, and a transceiver 868, among other components. The mobile computing device 850 can also be provided with a storage device, such as a micro-drive or other device, to provide additional storage. Each of the processor 852, the memory 864, the display 854, the communication interface 866, and the transceiver 868, are interconnected using various buses, and several of the components can be mounted on a common motherboard or in other manners as appropriate.

The processor 852 can execute instructions within the mobile computing device 850, including instructions stored in the memory 864. The processor 852 can be implemented as a chipset of chips that include separate and multiple analog and digital processors. The processor 852 can provide, for example, for coordination of the other components of the mobile computing device 850, such as control of user interfaces, applications run by the mobile computing device 850, and wireless communication by the mobile computing device 850.

The processor 852 can communicate with a user through a control interface 858 and a display interface 856 coupled to the display 854. The display 854 can be, for example, a TFT (Thin-Film-Transistor Liquid Crystal Display) display or an OLED (Organic Light Emitting Diode) display, or other appropriate display technology. The display interface 856 can comprise appropriate circuitry for driving the display 854 to present graphical and other information to a user. The control interface 858 can receive commands from a user and convert them for submission to the processor 852. In addition, an external interface 862 can provide communication with the processor 852, so as to enable near area communication of the mobile computing device 850 with other devices. The external interface 862 can provide, for example, for wired communication in some implementations, or for wireless communication in other implementations, and multiple interfaces can also be used.

The memory 864 stores information within the mobile computing device 850. The memory 864 can be implemented as one or more of a computer-readable medium or media, a volatile memory unit or units, or a non-volatile memory unit or units. An expansion memory 874 can also be provided and connected to the mobile computing device 850 through an expansion interface 872, which can include, for example, a SIMM (Single In Line Memory Module) card interface. The expansion memory 874 can provide extra storage space for the mobile computing device 850, or can also store applications or other information for the mobile computing device 850. Specifically, the expansion memory 874 can include instructions to carry out or supplement the processes described above, and can include secure information also. Thus, for example, the expansion memory 874 can be provide as a security module for the mobile computing device 850, and can be programmed with instructions that permit secure use of the mobile computing device 850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 864, the expansion memory 874, or memory on the processor 852. In some implementations, the computer program product can be received in a propagated signal, for example, over the transceiver 868 or the external interface 862.

The mobile computing device 850 can communicate wirelessly through the communication interface 866, which can include digital signal processing circuitry where necessary. The communication interface 866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 868 using a radio-frequency. In addition, short-range communication can occur, such as using a Bluetooth, WiFi, or other such transceiver (not shown). In addition, a GPS (Global Positioning System) receiver module 870 can provide additional navigation- and location-related wireless data to the mobile computing device 850, which can be used as appropriate by applications running on the mobile computing device 850.

The mobile computing device 850 can also communicate audibly using an audio codec 860, which can receive spoken information from a user and convert it to usable digital information. The audio codec 860 can likewise generate audible sound for a user, such as through a speaker, e.g., in a handset of the mobile computing device 850. Such sound can include sound from voice telephone calls, can include recorded sound (e.g., voice messages, music files, etc.) and can also include sound generated by applications operating on the mobile computing device 850.

The mobile computing device 850 can be implemented in a number of different forms, as shown in the figure. For example, it can be implemented as a cellular telephone 880. It can also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. An electronic gaming system using common playing cards, the system comprising:
a plurality of player computing devices that are configured to provide individualized gaming interfaces for a plurality of players; and
a gaming computing device that is in communication with the plurality of player computing devices, the gaming computing device configured to:
based on a plurality of sets of playing cards with one set of playing cards being dealt successive to another set of playing cards, continuously identify the plurality of sets of playing cards;
based on a request to play a game of roulette from at least one of the plurality of player computing devices, identify a first set of playing cards among the plurality of sets of playing cards being continuously identified;
receive, from at least one of the plurality of player computing devices, a bet on an outcome of the game of roulette;
identify, among the first set of playing cards, a first card;
determine a roulette value for the first card using mapping data, the mapping data indicating a mapping of card values to roulette values;
transmit, to each of the at least one of the plurality of player computing devices, data representative of the first card and the roulette value for the first card;
determine the outcome of the game of roulette for each of the plurality of player computing devices, wherein the outcome includes a payout based on the bet received from the respective player computing device of the plurality of player computing devices; and
return, to each of the at least one of the plurality of player computing devices, the outcome of the game of roulette.

2. The electronic gaming system of claim 1, further comprising:
a plurality of physical playing cards that are physically dealt by a dealer;
a scanner that is configured to identify each of the playing cards as they are dealt by the dealer, wherein the scanner is in communication with the gaming computing device; and
a plurality of gaming tables, wherein each of the plurality of gaming tables allows the dealer to deal the physical playing cards,
wherein the scanner is configured to read one or more of the physical playing cards for the gaming table.

3. The electronic gaming system of claim 2, wherein at least one of the plurality of player computing devices is physically located at at least one of the plurality of gaming tables.

4. The electronic gaming system of claim 2, wherein at least one of the plurality of player computing devices is physically remote from a location of at least one of the plurality of gaming tables.

5. The electronic gaming system of claim 1, wherein the gaming computing device is configured to deal the playing cards.

6. The electronic gaming system of claim 1, wherein each of the at least one of the plurality of player computing devices is configured to output, in a graphical user interface (GUI) display at the at least one of the plurality of player computing devices, a graphical representation of a roulette table.

7. The electronic gaming system of claim 6, wherein each of the at least one of the plurality of player computing devices is further configured to receive user input selecting a portion of the graphical representation of the roulette table, wherein the user input indicates the bet.

8. The electronic gaming system of claim 1, wherein the bet includes at least one of a player-selected roulette value, a player-selected pair of roulette values, a player-selected row of roulette values on a graphical representation of a roulette table, a player-selected column of roulette values on the graphical representation of the roulette table, player-selection of each corner of the graphical representation of the roulette table, player-selection of red roulette values on the graphical representation of the roulette table, player-selection of black roulette values on the graphical representation of the roulette table, player-selection of first, second, or third roulette values on the graphical representation of the roulette table, player-selection of a lower half of roulette values on the graphical representation of the roulette table, or player-selection of an upper half of roulette values on the graphical representation of the roulette table.

9. The electronic gaming system of claim 1, wherein, based on receiving the data representative of the first card and the roulette value for the first card, each of the at least one of the plurality of player computing devices is configured to output, in a GUI display at the at least one of the plurality of player computing devices, a graphical representation of the first card with the roulette value overlaying a portion of the graphical representation of the first card.

10. The electronic gaming system of claim 9, wherein the roulette value is displayed in a center portion of the graphical representation of the first card and an actual value of the first card is displayed in first and second corners of the graphical representation of the first card.

11. The electronic gaming system of claim 1, wherein the playing cards are physical playing cards and the gaming computing device is configured to translate the first set of playing cards into a first set of electronic cards.

12. The electronic gaming system of claim 1, wherein the first card is a first card in a card sequence in the first set of playing cards.

13. The electronic gaming system of claim 12, wherein the first set of playing cards is a set of five playing cards, and the gaming computing device is configured to discard second, third, fourth, and fifth cards in the card sequence in the first set of playing cards.

14. The electronic gaming system of claim 1, wherein identifying, among the first set of playing cards, a first card comprises identifying the first card in a card sequence of the first set of playing cards having a card value that is mapped to a roulette value in the mapping data.

15. The electronic gaming system of claim 14, wherein, in response to determining that none of the cards in the first set of playing cards have a card value that is mapped to a roulette value in the mapping data:
identifying a second set of playing cards among the plurality of sets of playing cards being continuously identified;
identifying, among the second set of playing cards, a first card; determining a roulette value for the first card in the second set of playing cards based on the mapping data;
transmitting, to each of the at least one of the plurality of player computing devices, data representative of the first card in the second set of playing cards and the roulette value for the first card in the second set of playing cards; and
determining the outcome of the game of roulette for the based at least in part on the roulette value for the first card in the second set of playing cards.

16. The electronic gaming system of claim 15, wherein the first set of playing cards is different than the second set of playing cards.

17. The electronic gaming system of claim 1, wherein the first card is identified among the first set of playing cards based on one or more card identification rules.

18. The electronic gaming system of claim 1, wherein the outcome of the game of roulette is determined based at least in part on one or more rules for playing a game of roulette.

19. The electronic gaming system of claim 1, wherein the gaming computing device is further configured to:
receive, from at least one of the at least one of the plurality of player computing devices, data representative of a side bet; and
determine one or more game outcomes for the at least one of the at least one of the plurality of player computing devices based on the side bet.

20. The electronic gaming system of claim 1, wherein the gaming computing device is further configured to provide, in GUI displays of the at least one of the plurality of player computing devices, selectable options to play multiple different games simultaneously with the plurality of sets of playing cards that are being continuously identified.
